(19) United States
(12) Patent Application Publication
(10) Pub. No.: US 2005/0276273 A1
(43) Pub. Date: Dec. 15, 2005

(54) Method and apparatus to facilitate inter-operability between a 3G1X network and a wireless packet data network

(76) Inventors: Valentin Oprescu-Surcobe, Northbrook, IL (US); Shahab M. Sayeedi, Naperville, IL (US)

Correspondence Address: MOTOROLA, INC., 1303 EAST ALGONQUIN ROAD, IL01/3RD, SCHAUMBURG, IL, 60196, US

(21) Appl. No.: 11/141,926

(22) Filed: Jun. 1, 2005

Related U.S. Application Data
(60) Provisional application No. 60/578,675, filed on Jun. 10, 2004.

(51) Int. Cl. H04L 12/28; H04L 12/56

(52) U.S. Cl. 370/401; 370/329

(57) ABSTRACT

To address the need for inter-operability between 3G1X networks and wireless packet data networks, architectural and messaging embodiments are described that provide for new interfaces Ay, Az, and Ap. The Ay interface supports messaging between a 3G1x base station (BS) (103) and a packet data network access network (AN), such as an HRPD AN (123). The Az interface supports messaging between a 3G1x base station (BS) and a packet data network packet control function (PCF), such as an HRPD PCF (125). The Ap interface supports messaging between a 3G1x PCF (105) and a packet data network PCF, such as an HRPD PCF. Using A8/A9 and Ap interfaces, then, messaging between a 3G1x BS and a packet data network PCF is enabled.

### REFERENCE(S) TO RELATED APPLICATION(S)

The present application claims priority from provisional application Ser. No. 60/578,675, entitled “METHOD AND APPARATUS TO FACILITATE INTER-OPERABILITY BETWEEN A 3G1X NETWORK AND A WIRELESS PACKET DATA NETWORK,” filed Jun. 10, 2004, which is commonly owned and incorporated herein by reference in its entirety.

### FIELD OF THE INVENTION

The present invention relates generally to wireless communication systems and, in particular, to facilitating inter-operability between a 3G1X network and a wireless packet data network.

### BACKGROUND OF THE INVENTION

At present, dual-mode (or hybrid) access terminals (ATs)/mobile stations (MSs) are able to obtain service from both 3G1X and wireless packet data networks. For example, such a dual-mode mobile may obtain its circuit-switched services from a 3G1X/1XEV-DV (DV) network and its packet data services from a High Rate Packet Data (HRPD)/1XEV-DO (DO) network that supports the TIA-856 air interface. However, in order to obtain service from both networks a dual-mode mobile currently must periodically monitor the frequency of whichever network it is not presently receiving or monitoring.

This operation is inefficient in that it can result in interruptions to an ongoing received service from one of the networks. Also, it can shorten battery life by requiring the extra monitoring, and it may require long paging cycles to allow the mobile enough time to monitor both networks. Thus, to reduce the mobile's monitoring burden, inter-operability between the networks is needed.

TIA-856-A includes a 3G1X Circuit Services Notification application which supports a protocol for sending notifications for 3G1X circuit-switched services to a hybrid AT via the CDMA2000 HRPD air interface while the AT is tuned to a CDMA2000 high rate packet data channel. These notifications include 1x Orders (, Status Request, Data Burst, General Page, and Feature Notification messages in the forward direction. 1x messages supported on the reverse link include Registration, Extended Status Response, Data Burst, and Order messages. TIA-2000-D provides a listing of all Order types and Data Burst types supported in the forward and reverse link direction over the air interface. Thus, cross-operation has been defined to some extent in the air interface standards, but no solution has been defined for network inter-operability.

One existing proposal presents a high level design and IOS call flows to support the new cdma2000 circuit services notification protocol (CSNP) introduced in TIA-856-A. It proposes extending the current A1 interface from the mobile switching center (MSC) to HRPD ANs. The MSC uses existing A1 interface messaging to signal circuit service notifications to the HRPD network.

In view of the present inefficiencies of hybrid mobiles monitoring two networks, it would be desirable to have additional solutions that facilitate inter-operability between 3G1X networks and wireless packet data networks.

### BRIEF DESCRIPTION OF THE DRAWINGS

FIG. 1 is a block diagram depiction of a wireless communication system that includes a 3G1X network interfaced with a wireless packet data network, in accordance with multiple embodiments of the present invention.

FIG. 2 is a block diagram depiction of exemplary deployment topologies for a wireless packet data network overlaid onto a 3G1X network, in accordance with multiple embodiments of the present invention.

FIG. 3 is a block diagram depiction of an anchored 3G1X base station configuration for a wireless packet data network overlaid onto a 3G1X network, in accordance with multiple embodiments of the present invention.

FIG. 4 is a block diagram depiction of an access network (AN)-base station (BS) 1:1 direct interface configuration for a wireless packet data network overlaid onto a 3G1X network, in accordance with multiple embodiments of the present invention.

FIG. 5 is a block diagram depiction of an access network (AN)-base station (BS) M:N direct interface configuration for a wireless packet data network overlaid onto a 3G1X network, in accordance with multiple embodiments of the present invention.

FIG. 6 is an exemplary call flow diagram depicting an AN initiated registration with 3G1X network for an anchored BS configuration, in accordance with multiple embodiments of the present invention.

FIG. 7 is an exemplary call flow diagram depicting an access terminal (AT) initiated 3G1X registration during an active packet data session on a high rate packet data (HRPD) network for an anchored BS configuration, in accordance with multiple embodiments of the present invention.

FIG. 8 is an exemplary call flow diagram depicting a AT initiated 3G1X registration during a dormant packet data session on a high rate packet data (HRPD) network for an anchored BS configuration, in accordance with multiple embodiments of the present invention.

FIG. 9 is an exemplary call flow diagram depicting a 1X voice page sent to an AT during an active HRPD packet data session for an anchored BS configuration, in accordance with multiple embodiments of the present invention.

FIG. 10 is an exemplary call flow diagram depicting a 1X voice page sent to an AT during a dormant HRPD packet data session for an anchored BS configuration, in accordance with multiple embodiments of the present invention.

FIG. 11 is an exemplary call flow diagram depicting a 1X voice page via an HRPD network when the AT is not found for an anchored BS configuration, in accordance with multiple embodiments of the present invention.

FIG. 12 is an exemplary call flow diagram depicting a 1x CSNP message sent to an AT during an active/dormant HRPD packet data session via short message service (SMS) for an anchored or direct BS configuration, in accordance with multiple embodiments of the present invention.

FIG. 13 is an exemplary call flow diagram depicting an AN initiated registration with 3G1X network for an AN-BS 1:1 direct interface configuration, in accordance with multiple embodiments of the present invention.

FIG. 14 is an exemplary call flow diagram depicting an AT initiated 3G1X registration during an active packet data session on an HRPD network for an AN-BS 1:1 direct interface configuration, in accordance with multiple embodiments of the present invention.

FIG. 15 is an exemplary call flow diagram depicting an AT initiated 3G1X registration during a dormant packet data session on an HRPD network for an AN-BS 1:1 direct interface configuration, in accordance with multiple embodiments of the present invention.

FIG. 16 is an exemplary call flow diagram depicting a 1X voice page for an AT during an active HRPD packet data session for an AN-BS 1:1 direct interface configuration, in accordance with multiple embodiments of the present invention.

FIG. 17 is an exemplary call flow diagram depicting a 1X voice page sent to an AT during a dormant HRPD packet data session for an AN-BS 1:1 direct interface configuration, in accordance with multiple embodiments of the present invention.

FIG. 18 is an exemplary call flow diagram depicting an AN initiated registration with 3G1X network for an AN-BS M:N direct interface configuration, in accordance with multiple embodiments of the present invention.

FIG. 19 is an exemplary call flow diagram depicting an AN initiated registration with 3G1X network for an AN-BS M:N direct interface configuration, in accordance with multiple embodiments of the present invention.

FIG. 20 is an exemplary call flow diagram depicting an AT initiated 3G1X registration on an HRPD network for an AN-BS M:N direct interface configuration, in accordance with multiple embodiments of the present invention.

FIG. 21 is an exemplary call flow diagram depicting a 1X voice page for an AT during an active HRPD packet data session for an AN-BS M:N direct interface configuration, in accordance with multiple embodiments of the present invention.

FIG. 22 is an exemplary call flow diagram depicting an HRPD PCF initiated registration with 3G1X network, in accordance with multiple embodiments of the present invention.

FIG. 23 is an exemplary call flow diagram depicting an AT initiated 3G1X registration on an HRPD network, in accordance with multiple embodiments of the present invention.

FIG. 24 is an exemplary call flow diagram depicting a 1X voice page for an AT during an active/dormant HRPD packet data session, in accordance with multiple embodiments of the present invention.

FIG. 25 is an exemplary call flow diagram depicting a RL message supported by the CSNP protocol received an active/dormant HRPD packet data session, in accordance with multiple embodiments of the present invention.

FIG. 26 is a block diagram depiction of a cdma2000 wireless communication system, in accordance with IOS specifications.

FIG. 27 is a block diagram depiction of an HRPD IOS Phase 1 Architecture, in accordance with IOS specifications.

FIG. 28 is a block diagram depiction of an HRPD Packet Data Mobility Architecture, in accordance with IOS specifications.

FIG. 29 is a block diagram depiction of an HRPD IOS Alternative Architecture, in accordance with IOS specifications.

### DETAILED DESCRIPTION OF EMBODIMENTS

To address the need for inter-operability between 3G1X networks and wireless packet data networks, architectural and messaging embodiments are described that provide for new interfaces Ay, Az, and Ap. The Ay interface supports messaging between a 3G1x base station (BS) and a packet data network access network (AN), such as an HRPD AN. The Az interface supports messaging between a 3G1x base station (BS) and a packet data network packet control function (PCF), such as an HRPD PCF. The Ap interface supports messaging between a 3G1x PCF and a packet data network PCF. Using A8/A9 and Ap interfaces, then, messaging between a 3G1x BS and a packet data network PCF is enabled.

Embodiments of the present invention encompass a method to facilitate inter-operability between a 3G1x network and a wireless packet data network. The method comprises receiving, by a 3G1x radio access network (RAN), registration update messaging for a remote unit from a packet data network RAN. The method further comprises, in response to receiving the registration update messaging, sending, by the 3G1x RAN, 3G1x registration update messaging for the remote unit to a mobile switching center (MSC) and sending, by the 3G1x RAN, registration response messaging for the remote unit to the packet data network RAN.

Embodiments of the present invention encompass another method to facilitate inter-operability between a 3G1x network and a wireless packet data network. The method comprises receiving, by a packet data network radio access network (RAN), registration signaling from a remote unit. The method further comprises, in response to receiving the registration signaling, sending, by the packet data network RAN, registration messaging for the remote unit to a 3G1x RAN and sending, by the packet data network RAN, registration response signaling to the remote unit.

Embodiments of the present invention encompass yet another method to facilitate inter-operability between a 3G1x network and a wireless packet data network. The method comprises receiving, by a 3G1x radio access network (RAN), circuit network-originated paging request messaging for a remote unit from a mobile switching center (MSC), sending, by the 3G1x RAN in response to receiving the circuit network-originated paging request messaging, RAN-originated paging request messaging for the remote unit to a packet data network RAN, and receiving, by the 3G1x RAN in response to sending the RAN-originated paging request messaging, page response messaging for the remote unit.

Embodiments of the present invention encompass yet another method to facilitate inter-operability between a 3G1x network and a wireless packet data network. The method comprises receiving, by a packet data network radio access network (RAN), RAN-originated paging request messaging for a remote unit from a 3G1x RAN, paging the remote unit by the packet data network RAN in response to receiving the RAN-originated paging request messaging, and sending, by the packet data network RAN in response to receiving the RAN-originated paging request messaging, RAN-originated page response messaging to the 3G1x RAN.

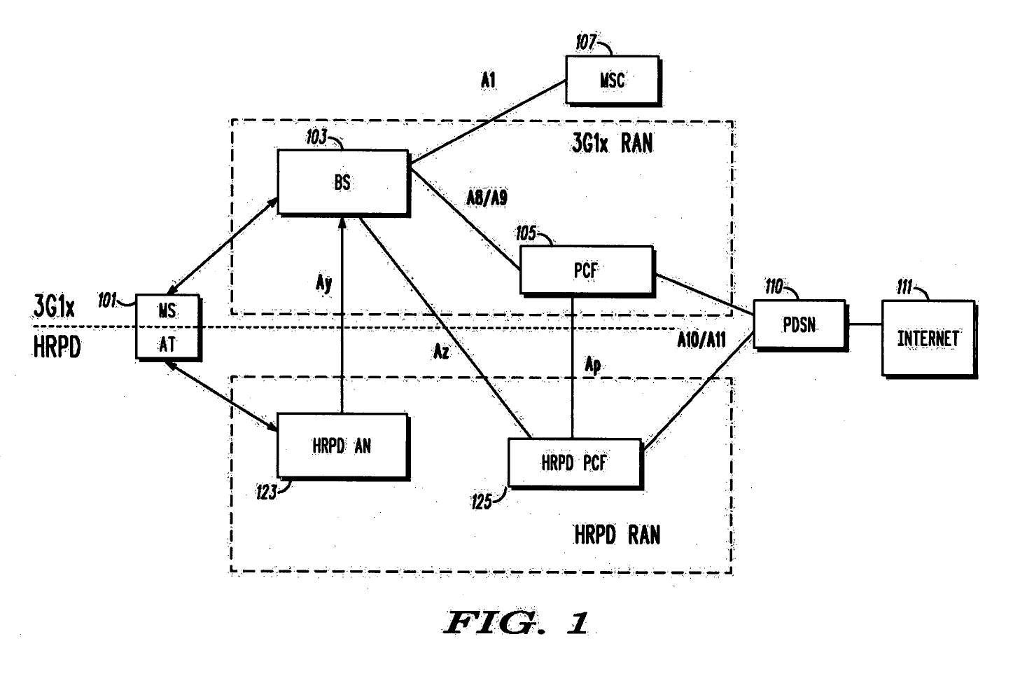

FIG. 1 is a block diagram depiction of a wireless communication system that includes a 3G1X network interfaced with a wireless packet data network, in accordance with multiple embodiments of the present invention. The wireless packet data network depicted in FIG. 1 is an HRPD network. However, the present invention is not limited to HRPD networks. For example, the wireless communication system of FIG. 1 may instead or additionally include a wireless packet data network such as one based on IEEE 802.16 and/or 802.20 networks. Also, MS/AT 101 is often referred to as a hybrid mobile, MS/ATs in the present invention are not limited to mobile devices per se. For example, an MS may comprise all manner of devices wirelessly connected to the radio access network such as computers, personal data assistants (PDAs), gaming devices, etc.

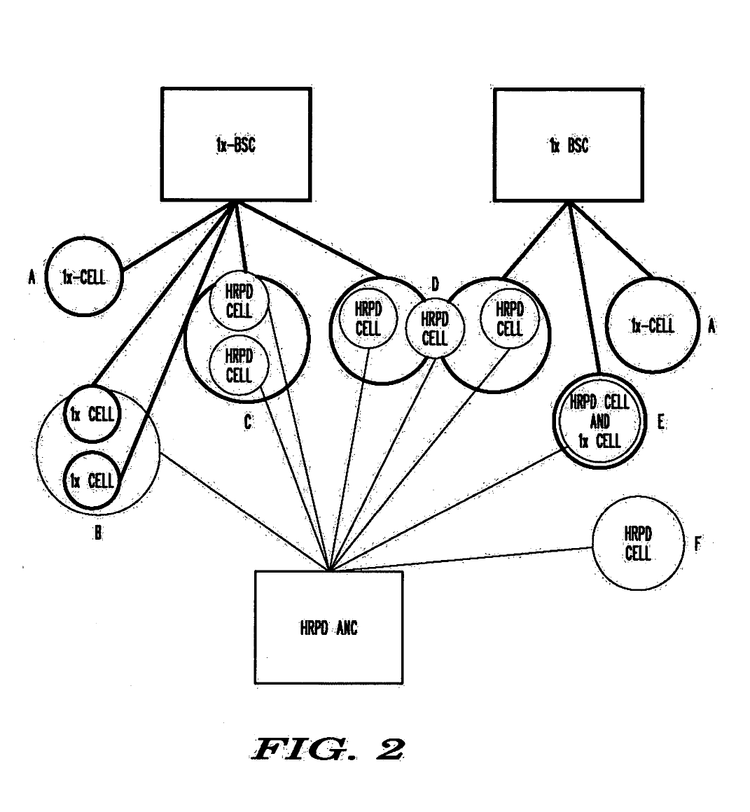

FIG. 2 is a block diagram depiction of exemplary deployment topologies for a wireless packet data network overlaid onto a 3G1X network, in accordance with multiple embodiments of the present invention. The bold lines of FIG. 2 correspond to a 3G1x network entities and interfaces. The remaining lines of FIG. 2 correspond to HRPD network entities and interfaces. 1x BTSs and HRPD ANTSs may be overlaid in a 1:1 or M:N configuration. A BTS/ANTS may be overlaid over two or more cells. Depending on the network configuration, paging zones may be split across overlaid cells. Various topologies are depicted in FIG. 2:
Topology A: 1x cell with no HRPD overlay;
Topology B: 1 HRPD cell overlaid over multiple 1x cells;
Topology C: Multiple HRPD cells overlaid over one 1x cell;
Topology D: Multiple HRPD cells overlaid over multiple 1x cells and paging zone may be split in middle cell;
Topology E: 1 HRPD cell overlaid over 1x cell; and
Topology F: HRPD cell with no 1x coverage.

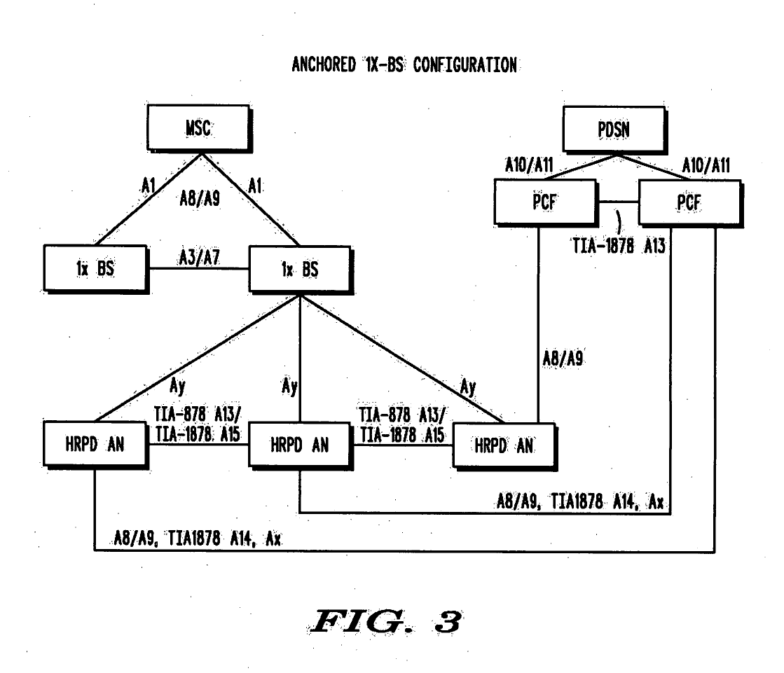

FIGS. 3-5 depict alternative configurations for supporting CSNP via an Ay interface. A 1x anchored BS configuration, an AN configuration overlaid 1:1 over the 1x network, and an AN configuration overlaid M:N over the 1x network. The following assumptions are made in the discussion of these configurations. While the 1x network may also support packet data services, for discussion purposes, it is assumed here that the 1x network is used to support circuit services. Packet data calls are supported by the packet data network (HRPD, e.g.). While paging and registration are discussed for the architecture, other 1x messages supported by the CSNP are also supported by the architectures.

FIG. 3 is a block diagram depiction of an anchored 3G1X base station configuration for a wireless packet data network overlaid onto a 3G1X network, in accordance with multiple embodiments of the present invention. In an anchored BS architecture, the hybrid AT/MS is registered with the MSC under the anchor BS's paging zone. The anchor BS is responsible for sending and receiving 1x signaling messages to and from the hybrid AT/MS via the HRPD ANs. If the anchor BS maintains an IMSI-AN mapping, flood paging can be avoided.

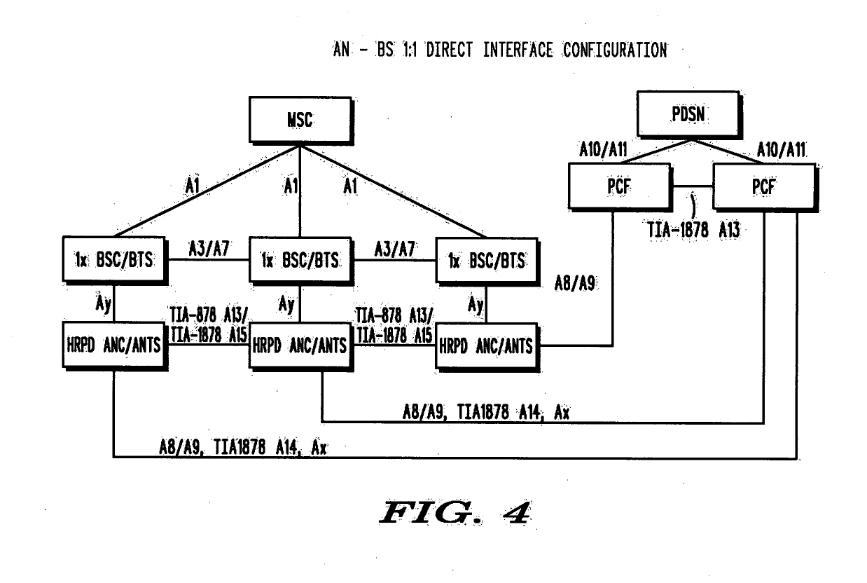

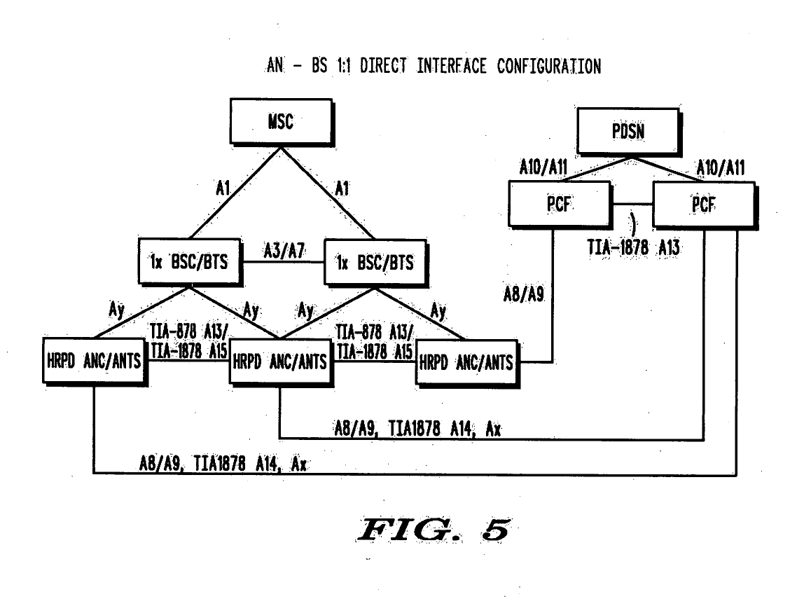

FIGS. 4 and 5 are block diagram depictions of an access network (AN)-base station (BS) 1:1 and M:N direct interface configuration for a wireless packet data network overlaid onto a 3G1X network, in accordance with multiple embodiments of the present invention. Unlike the anchored configuration, there are multiple BSs that may send and receive 1x signaling messages to and from the hybrid AT/MS via their overlaid HRPD AN counterparts. If each BS maintains IMSI/AN mapping, paging messages over Ay are targeted to AN where MS is registered and may prevent double paging.

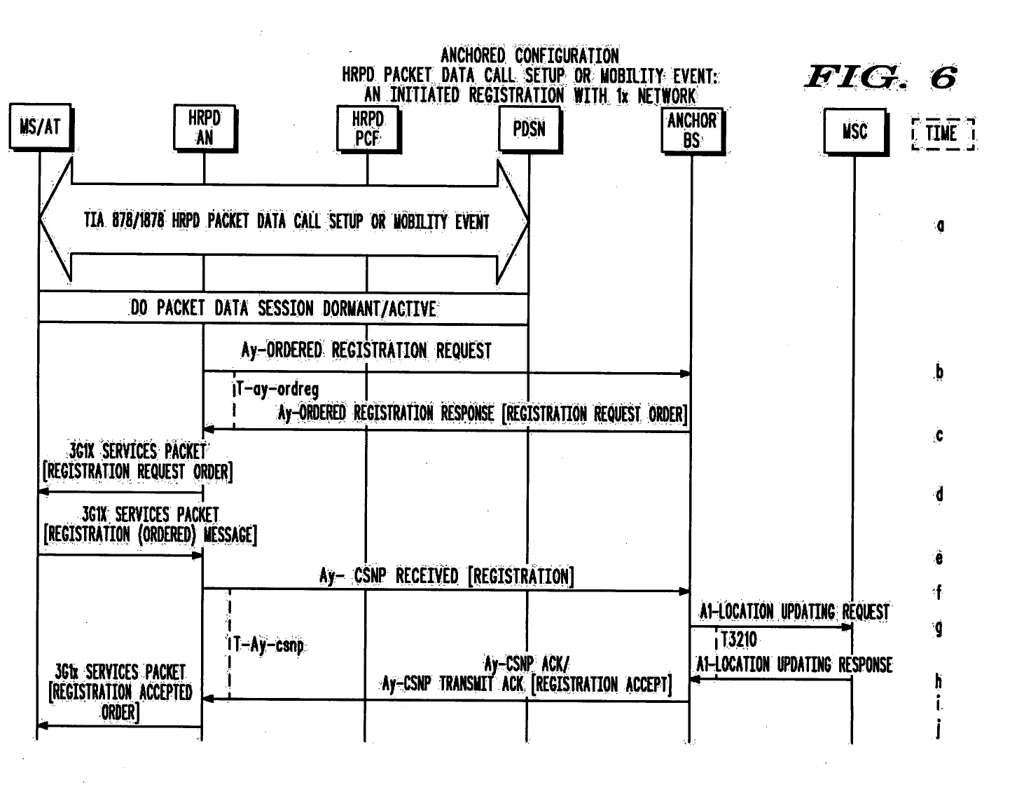

FIG. 6 is an exemplary call flow diagram depicting an AN initiated registration with 3G1X network for an anchored BS configuration, in accordance with multiple embodiments of the present invention. The following is a detailed description of the call flow timeline as labeled on the rightmost column of FIG. 6:
a. A call setup or mobility event occurs at an AN in an HRPD overlaid network. The Hybrid AT and HRPD network use existing TIA-878 or TIA-1878 procedures to complete the procedures. The PCF passes the AT's IMSI to the AN in the A9-Connect-A8 or A9-Release-A8 Complete message. The AN stores the UATI IMSI mapping. The PCF includes an indication requesting the AN to initiate registration.
b. The AN sends an Ay-Ordered Registration Request message to the BS to request the BS to initiate a 1x ordered registration procedure. The AN starts timer T-ay-ordreg.
c. The BS sends an Ay-Ordered Registration Response message to the AN.
d. The AN sends a 3G1x Services Packet containing a TIA-2000 Registration Request Order to the AT.
e. The AT responds with a 3G1x Services Packet containing TIA-2000 Registration message.
f. The AN forwards the mobile's Registration message in the Ay-CSNP Received message to the HRPD anchored BS. The AN then starts timer T_{ay-csnp}.
g. Upon reception of the Ay-CSNP Received message from the HRPD AN, the BS constructs a Location Updating Request message, places it in the Complete Layer 3 Information message, and sends it to the MSC. The BS then starts timer T₃₂₁₀.
h. The MSC sends the Location Updating Accept message to the BS to indicate that the Location Updating Request message has been processed. The AT is now registered at the MSC at the HRPD anchor BS. Upon receipt of the Location Updating Accept message, the BS stops timer T₃₂₁₀. The anchor BS maps the AT's IMSI to the AN.
i. The HRPD anchor BS sends an Ay-CSNP Ack (no message to send to MS) or Ay-CSNP Transmit Ack message containing a Registration Accepted Order to the HRPD AN. Upon receipt of either message, the BS stops timer T_{ay-csnp}.
j. If an AN-CSNP Transmit Ack is sent to the AN, the AN sends a 3G1x Services Packet Registration Accepted Order to the MS to indicate a successful ordered registration procedure.

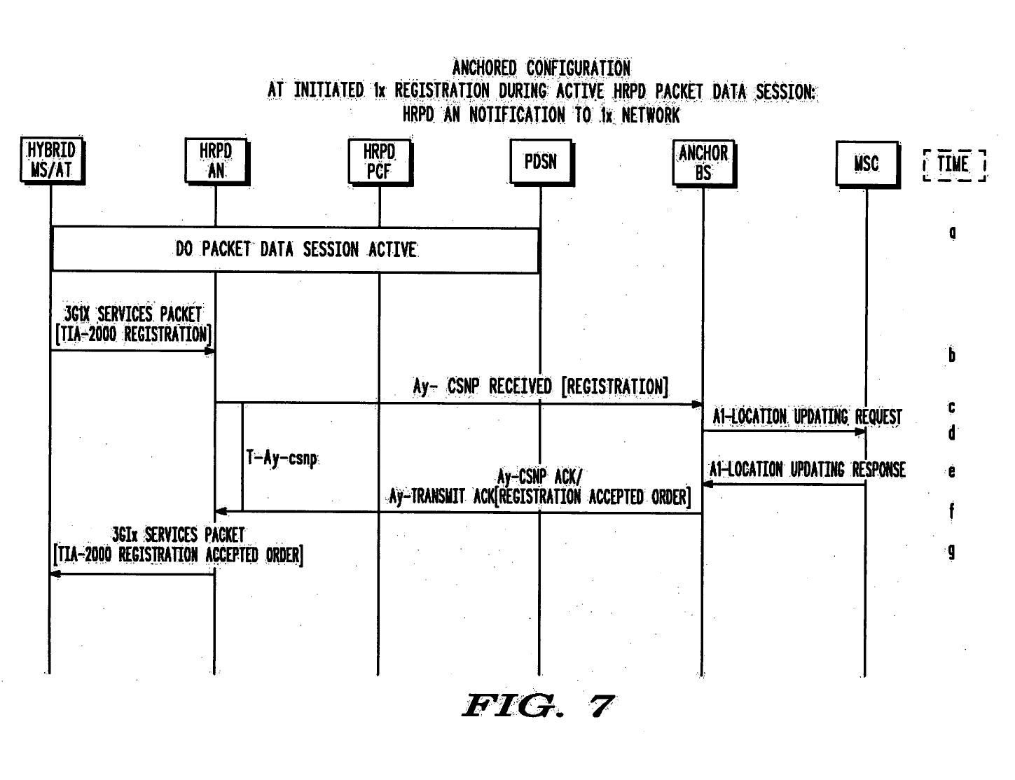

FIG. 7 is an exemplary call flow diagram depicting an access terminal (AT) initiated 3G1X registration during an active packet data session on a high rate packet data (HRPD) network for an anchored BS configuration, in accordance with multiple embodiments of the present invention. The following is a detailed description of the call flow timeline as labeled on the rightmost column of FIG. 7:
a. The Hybrid AT is engaged in active packet data session with an overlaid HRPD network. The Hybrid AT sends a 3G1X Services Packet containing a TIA-2000 Registration message to the AN.
b. The AN forwards the mobile's Registration message in the Ay-Registration Update Request message to the HRPD anchored BS.

The AN then starts timer T_{ay-csnp}.
c. Upon reception of the Ay-Registration Update Request message from the HRPD AN, the BS constructs a Location Updating Request message, places it in the Complete Layer 3 Information message, and sends it to the MSC. The BS then starts timer T₃₂₁₀.
d. The MSC sends the Location Updating Accept message to the BS to indicate that the Location Updating Request message has been processed. The AT is now registered at the MSC at the HRPD anchor BS. Upon receipt of the Location Updating Accept message, the BS stops timer T₃₂₁₀. The anchor BS maps the AT's IMSI to the AN.
e. The HRPD anchor BS sends an Ay-CSNP Ack (no message to send to MS) or Ay-CSNP Transmit Ack message containing a Registration Accepted Order to the HRPD AN. Upon receipt of either message, the BS stops timer T_{ay-csnp}.
f. If an AN-CSNP Transmit Ack (includes IMSI) is sent to the AN, the AN sends a 3G1x Services Packet Registration Accepted Order to the MS to indicate a successful ordered registration procedure.

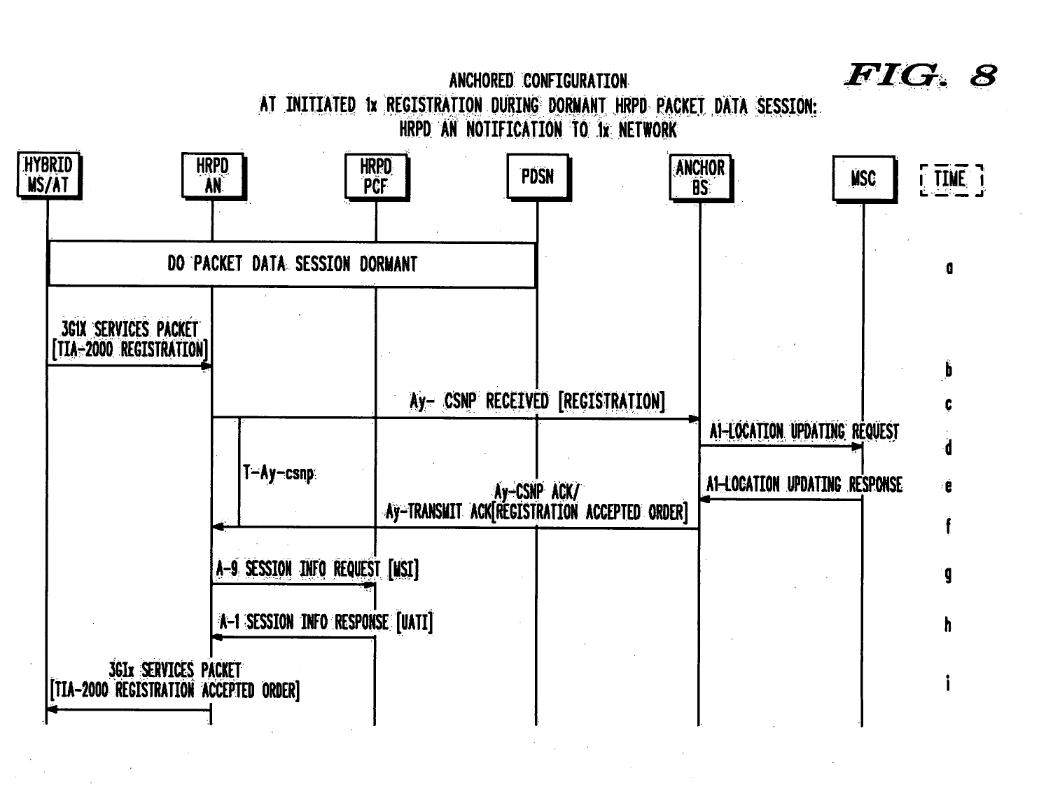

FIG. 8 is an exemplary call flow diagram depicting a AT initiated 3G1X registration during a dormant packet data session on a high rate packet data (HRPD) network for an anchored BS configuration, in accordance with multiple embodiments of the present invention. The following is a detailed description of the call flow timeline as labeled on the rightmost column of FIG. 8:
a. The Hybrid AT is engaged in a dormant packet data session with an overlaid HRPD network.
b. The Hybrid AT sends a 3G1X Services Packet containing a TIA-2000 Registration message to the AN.
c. The AN forwards the mobile's Registration message in the Ay-Registration Update Request message to the HRPD anchored BS. The AN then starts timer T_{ay-csnp}.
d. Upon reception of the Ay-Registration Update Request message from the HRPD AN, the BS constructs a Location Updating Request message, places it in the Complete Layer 3 Information message, and sends it to the MSC. The BS then starts timer T₃₂₁₀.
e. The MSC sends the Location Updating Accept message to the BS to indicate that the Location Updating Request message has been processed. The AT is now registered at the MSC at the HRPD anchor BS. Upon receipt of the Location Updating Accept message, the BS stops timer T₃₂₁₀. The anchor BS maps the AT's IMSI to the AN.
f. The HRPD anchor BS sends an Ay-CSNP Ack (no message to send to MS) or Ay-CSNP Transmit Ack message containing a Registration Accepted Order to the HRPD AN. The mobile IMSI is included in the message. Upon receipt of either message, the AN stops timer T_{ay-csnp}.

The next steps only occur if the BS sent an Ay-CSNP Transmit Ack message to the AN
g. The AN sends an A9-Session Info request message with the received IMSI to the PCF and starts the T_{A9-sessinfo} timer.
h. The PCF uses the received IMSI to locate the UATI allocated to the AT and sends it back to the AN in the A9-Session Info Response message. The AN stops the T_{A9-sessinfo} timer.
i. The AN sends a 3G1x Services Packet Registration Accepted Order to the MS to indicate a successful ordered registration procedure.

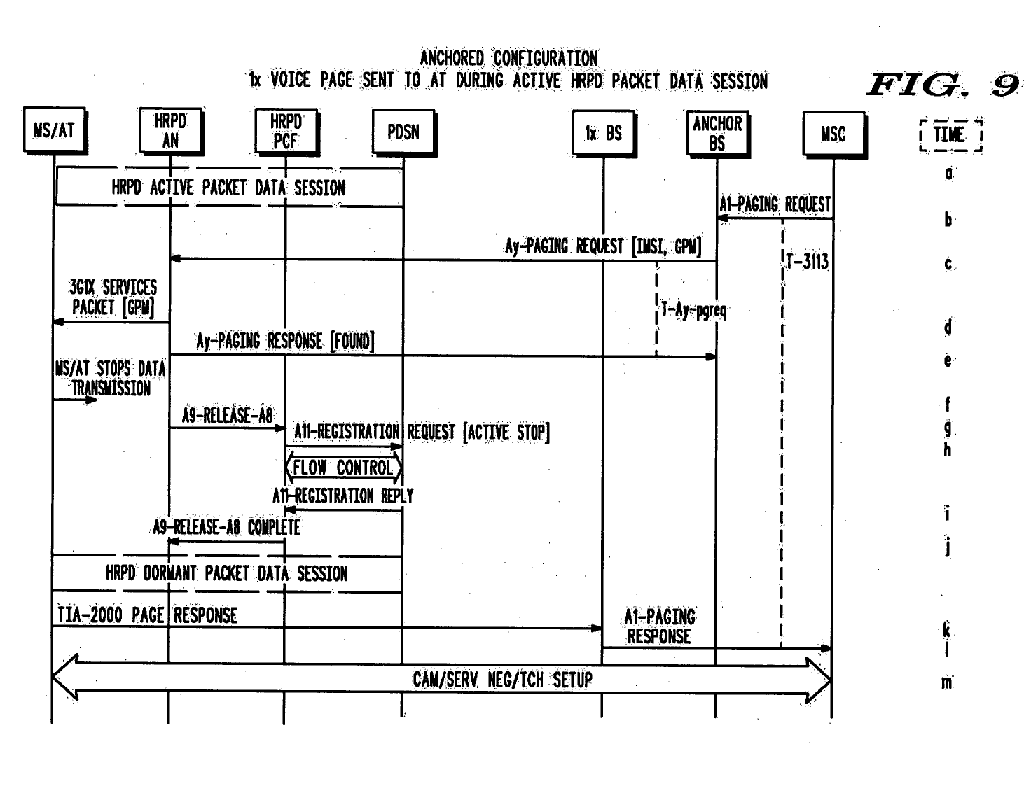

FIG. 9 is an exemplary call flow diagram depicting a 1X voice page sent to an AT during an active HRPD packet data session for an anchored BS configuration, in accordance with multiple embodiments of the present invention. The following is a detailed description of the call flow timeline as labeled on the rightmost column of FIG. 9:
a. A hybrid AT is engaged in an active packet data session on an overlaid HRPD packet data network. The PCF sends the IMSI to the AN when the A8 bearer connection is established. The AN maintains the AT's IMSI/UATI mapping when it's packet data session is active.
b. The MSC determines that an incoming call terminates to an AT within its serving region and sends a A1-Paging Request message to the HRPD anchor BS to initiate a mobile terminated call setup procedure. The MSC may be unaware that the AT is engaged in a packet data session at the HRPD network. The MSC starts timer T₃₁₁₃.
c. The HRPD anchor BS may send a GPM message over the air The AN sends an Ay-Paging Request message (containing the A1-Paging Request message) to ANs in the HRPD network. If the HRPD anchor BS maintains an IMSI/AN mapping table (updated during registrations), the Page message is only sent to the AN in the HRPD network where the mobile registered. The HRPD Anchor BS starts timer T_{Ay-pgreq}.
d. The AN uses the received IMSI to find the UATI assigned to the AT to be paged. The AN sends a 3G1X Services Packet containing a 1x GPM to the AT.
e. The AN responds with an Ay-Paging Response message to the HRPD Anchor BS indicating that the AT was found. The BS stops timer T_{Ay-pgreq} upon receipt of the Ay-Paging Response message from the BS.
f. The AT stops data transmission to the HRPD network.
g. The AN detects the loss of transmission after a timeout and sends an A9-Release A8 message to the PCF with cause value indicating ‘Air link lost’ to the PCF and starts timer Tᵣₑₗ₉.
h. The PCF sends an A11-Registration Request message containing an Active Stop accounting record to the PDSN and starts timer T_{regreq}. If the PDSN supports GRE packet flow control for the connection, the PCF may request flow control be started if supported for the connection to prevent a network initiated reactivation of the packet data session.
i. The PDSN sends an A11-Registration Reply message to the PCF. The PCF stops timer T_{regreq} upon receipt of this message.
j. The PCF sends an A9-Release-A8 Complete message to the AN. The AN stops timer Tᵣₑₗ₉.
k. The AT sends a 1x Page Response message to the BS. This step may occur any time after step e.
l. The BS sends an A1-Page Response message to the MSC.
m. Existing TIA-2000 and IOS procedures are used to complete the set up of the 1x voice call.

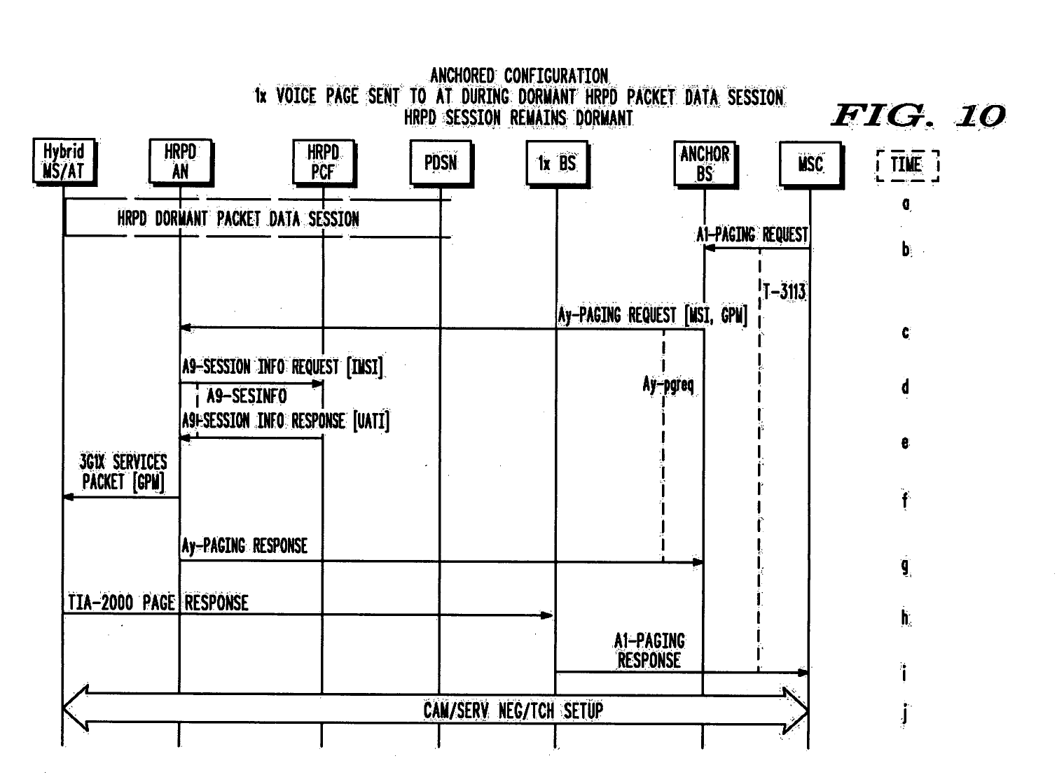

FIG. 10 is an exemplary call flow diagram depicting a 1X voice page sent to AT during a dormant HRPD packet data session for an anchored BS configuration, in accordance with multiple embodiments of the present invention. The following is a detailed description of the call flow timeline as labeled on the rightmost column of FIG. 10:
a. A hybrid AT is engaged in a dormant packet data session on an overlaid HRPD packet data network.
b. The MSC determines that an incoming call terminates to an AT within its serving region and sends a A1-Paging Request message to the HRPD anchor BS to initiate a mobile terminated call setup procedure. The MSC may be unaware that the AT is engaged in a packet data session at the HRPD network. The MSC starts timer T₃₁₁₃.
c. The HRPD anchor BS forwards the Page message in a GPM over the air and in an Ay-Paging Request message to ANs in the HRPD network. If the HRPD anchor BS maintains an IMSI/AN mapping table, the Page message is sent to the AN in the HRPD network where the mobile is registered. The HRPD Anchor BS starts timer T_{Ay-pgreq}.
d. The AN is unable to match the IMSI received in the Ay-Paging Request message to a UATI allocated for an active packet data call on the AN. The AN sends an A9-Session Info request message with the received IMSI to the PCF and starts the T_{A9-sessinfo} timer
e. The PCF uses the received IMSI to locate the UATI allocated to the AT and sends it back to the AN in the A9-Session Info Response message. The AN stops the T_{A9-sessinfo} timer.
f. The AN sends a 3G1X Services Packet containing a 1x GPM to the AT. Note: the AN may request the PCF to initiate flow control with the PDSN for the dormant session so the mobile doesn't receive a network initiated packet data session.
g. The AN responds with an Ay-Paging Response message to the HRPD Anchor BS indicating that the AT was found. The BS stops timer T_{Ay-pgreq} upon receipt of the Paging Response message from the BS.
h. The AT sends a Page Response message to the BS. This step can occur any time after step g.
i. The BS sends a Page Response message to the MSC.
j. Existing TIA-2000 and IOS procedures are used to complete the set up of the 1x voice call.

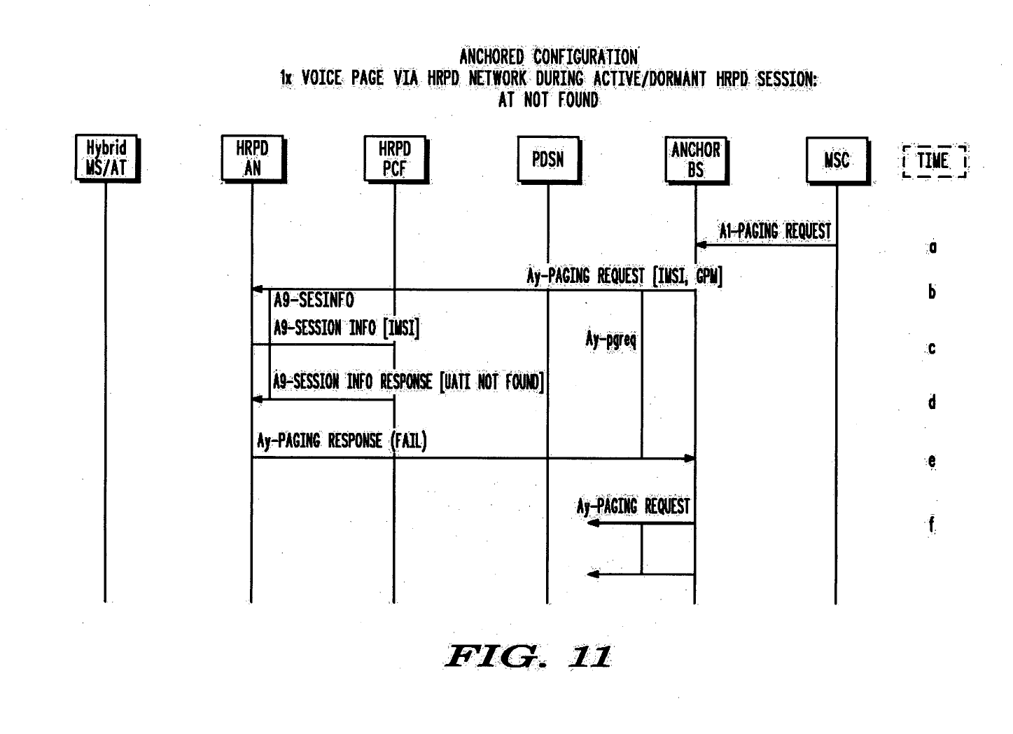

FIG. 11 is an exemplary call flow diagram depicting a 1X page via an HRPD network when the AT is not found for an anchored BS configuration, in accordance with multiple embodiments of the present invention. The following is a detailed description of the call flow timeline as labeled on the rightmost column of FIG. 11:
a. The MSC determines that an incoming call terminates to an AT within its serving region and sends a A1-Paging Request message to the HRPD anchor BS to initiate a mobile terminated call setup procedure. The MSC is unaware that the AT is engaged in a packet data session at the HRPD network. The MSC starts timer T₃₁₁₃.
b. The HRPD anchor BS forwards the Page message in a GPM over the air and in an Ay-Paging Request message to ANs in the HRPD network. If the HRPD anchor BS maintains an IMSI/AN mapping table, the Page message is sent to the AN in the HRPD network where the mobile is registered. The HRPD Anchor BS starts timer T_{Ay-pgreq}.
c. The AN is unable to match the IMSI received in the Ay-Paging Request message to a UATI allocated for an active packet data call on the AN. The AN sends an A9-Session Info request message with the received IMSI to the PCF and starts the T_{A9-sessinfo} timer
d. The PCF is unable to locate a UATI associated with the IMSI. The PCF sends an A9-Session Info Response message to the AN with an indication that a UATI was not found. The AN stops the T_{A9-sessinfo} timer.
e. The AN responds with an Ay-Paging Response message to the HRPD Anchor BS indicating failure. The BS stops timer T_{Ay-pgreq} upon receipt of the Paging Response message from the BS.
f. The HRPD anchor BS may send Ay Paging Request messages to other ANs.

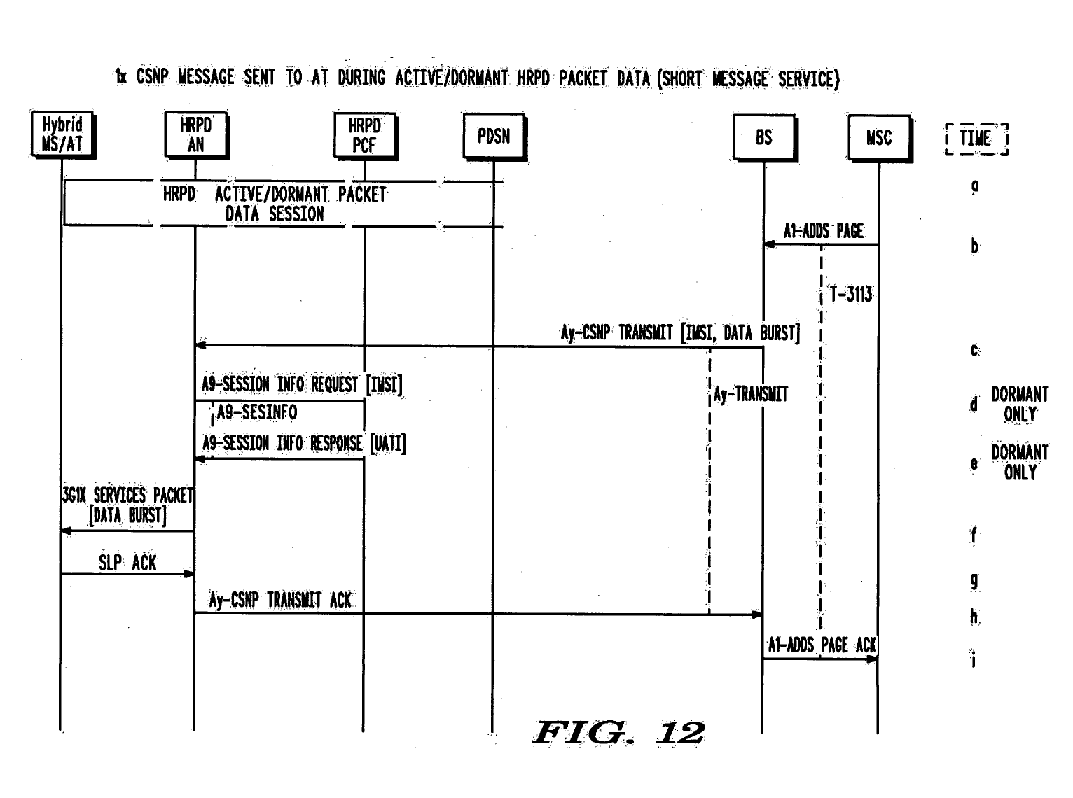

FIG. 12 is an exemplary call flow diagram depicting a 1x CSNP message containing a forward link 1x air interface message supported by the CSNP protocol sent to an AT during an active/dormant HRPD packet data session for an anchored or direct interface BS configuration, in accordance with multiple embodiments of the present invention. While Short Message Services are shown as an example, other TIA02000 forward link air interface messaging with the corresponding A1 signaling procedure can also be supported by the flow. The following is a detailed description of the call flow timeline as labeled on the rightmost column of FIG. 12:
a. A hybrid AT is engaged in a dormant packet data session on an overlaid HRPD packet data network. If the session is active, the AN maintains IMSI/UATI mapping for the AT.
b. The MSC sends a circuit services message to the BS (ADDS Page for SMS shown as an example in this case). The MSC starts timer T3113.
c. The BS forwards the 1x Data Burst in an Ay-CSNP Transmit message to an AN in the HRPD network and starts T_{Ay-transmit}.

Steps d-e only occur if the AT's packet data session is not active or the UATI is not found at the AN.
d. The AN is unable to match the IMSI received in the Ay-CSNP Transmit message to a UATI allocated for an active packet data call on the AN. The AN sends an A9-Session Info request message with the received IMSI to the PCF and starts the T_{A9-sessinfo} timer
e. The PCF responds with an A9-Session Info Response message to the AN with the UATI for the AT.
f. The AN sends the 1x message (Data Burst) to the AT.
g. If the AN requests an acknowledgement, the AT acknowledges the receipt of the message by sending an HRPD SLP Ack.
h. The AT sends an Ay Transmit Ack message to the BS. The BS stops timer Ay-transmit.
ilf the MSC requested an acknowledgment by including the Tag information element in the ADDS Page message, the BS replies with an ADDS Page Ack message including the Tag information

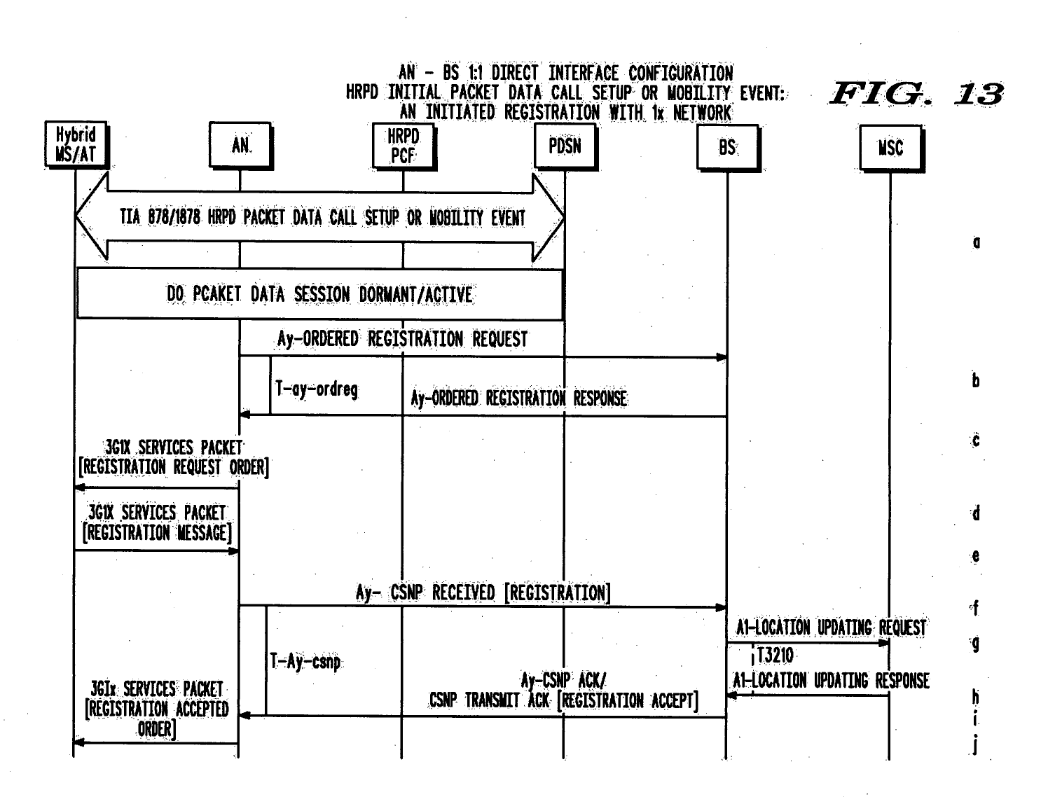

FIG. 13 is an exemplary call flow diagram depicting an AN initiated registration with 3G1X network for an AN-BS 1:1 direct interface configuration, in accordance with multiple embodiments of the present invention. The following is a detailed description of the call flow timeline as labeled on the rightmost column of FIG. 13:
a. A call setup or mobility event occurs at an AN in an HRPD overlaid network. The Hybrid AT and HRPD network use existing TIA-878 or TIA-1878 procedures to complete the procedures. The PCF passes the AT's IMSI to the AN in the A9-Connect-A8 or A9-Release-A8 Complete message. The AN stores the UATI IMSI mapping. The PCF includes an indication requesting the AN to initiate registration.
b. The AN sends an Ay-Ordered Registration Request message to the BS to request the BS to initiate a 1x ordered registration procedure. The AN starts timer T-ay-ordreg.
c. The BS sends an Ay-Ordered Registration Response message to the AN.
d. The AN sends a 3G1x Services Packet containing a TIA-2000 Registration Request Order to the AT.
e. The AT responds with a 3G1x Services Packet containing TIA-2000 Registration message.
f. The AN forwards the mobile's Registration message in the Ay-CSNP Received message to the 1x BS. The AN then starts timer T_{ay-csnp}.
g. Upon reception of the Ay-CSNP Received message from the HRPD AN, the BS constructs a Location Updating Request message, places it in the Complete Layer 3 Information message, and sends it to the MSC. The BS then starts timer T₃₂₁₀.
h. The MSC sends the Location Updating Accept message to the BS to indicate that the Location Updating Request message has been processed. The AT is now registered at the MSC at the 1x BS. Upon receipt of the Location Updating Accept message, the BS stops timer T₃₂₁₀. The anchor BS maps the AT's IMSI to the AN.
i. The BS sends an Ay-CSNP Ack (no message to send to MS) or Ay-CSNP Transmit Ack message containing a Registration Accepted Order to the HRPD AN. Upon receipt of either message, the BS stops timer T_{ay-csnp}.
j. If an AN-CSNP Transmit Ack was sent to the AN, the AN sends a 3G1x Services Packet containing a Registration Accepted Order to the MS to indicate a successful ordered registration procedure.

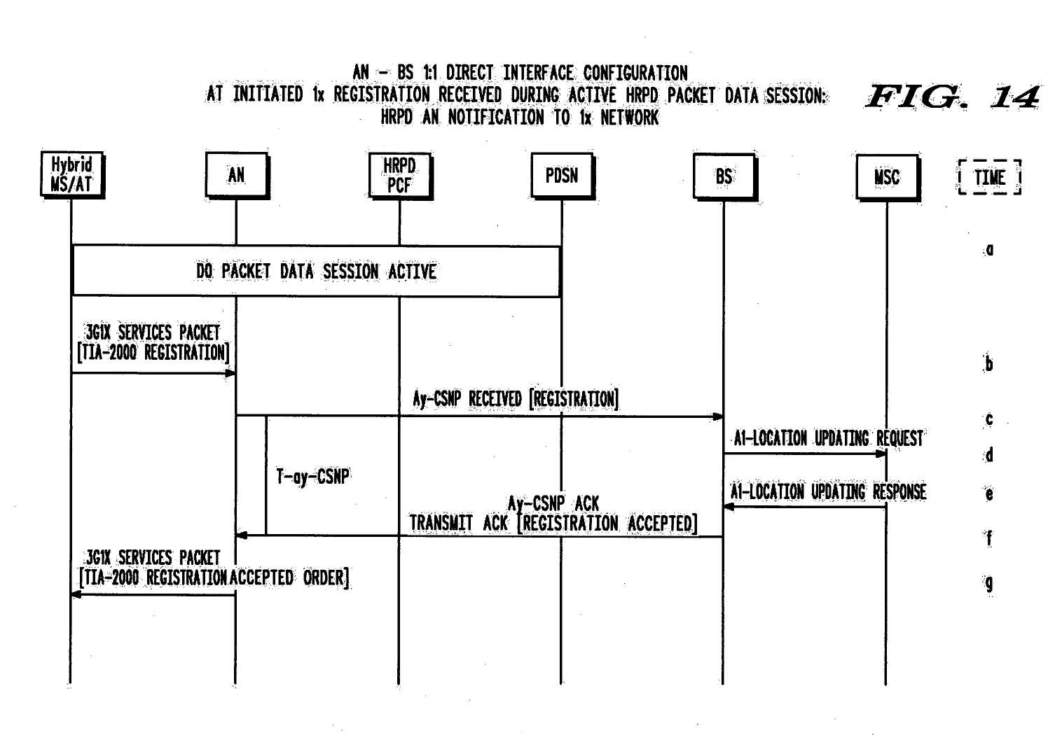

FIG. 14 is an exemplary call flow diagram depicting an AT initiated 3G1X registration during an active packet data session on an HRPD network for an AN-BS 1:1 direct interface configuration, in accordance with multiple embodiments of the present invention. The following is a detailed description of the call flow timeline as labeled on the rightmost column of FIG. 14:
a. The Hybrid AT is engaged in an active packet data session with an overlaid HRPD network.
b. The Hybrid AT sends a 3G1X Services Packet containing a TIA-2000 Registration message to the AN.
c. The AN forwards the mobile's Registration message in the Ay-Registration Update Request message to the BS. The AN then starts timer T_{ay-csnp}.
d. Upon reception of the Ay-Registration Update Request message from the HRPD AN, the BS constructs a Location Updating Request message, places it in the Complete Layer 3 Information message, and sends it to the MSC. The BS then starts timer T₃₂₁₀.
e. The MSC sends the Location Updating Accept message to the BS to indicate that the Location Updating Request message has been processed. The AT is now registered at the MSC at the 1x BS. Upon receipt of the Location Updating Accept message, the BS stops timer T₃₂₁₀. The anchor BS maps the AT's IMSI to the AN.
f. The BS sends an Ay-CSNP Ack (no message to send to MS) or Ay-CSNP Transmit Ack message containing a Registration Accepted Order to the HRPD AN. Upon receipt of either message, the BS stops timer T_{ay-csnp}.
g. If an AN-CSNP Transmit Ack (includes IMSI) is sent to the AN, the AN sends a 3G1x Services Packet Registration Accepted Order to the MS to indicate a successful ordered registration procedure.

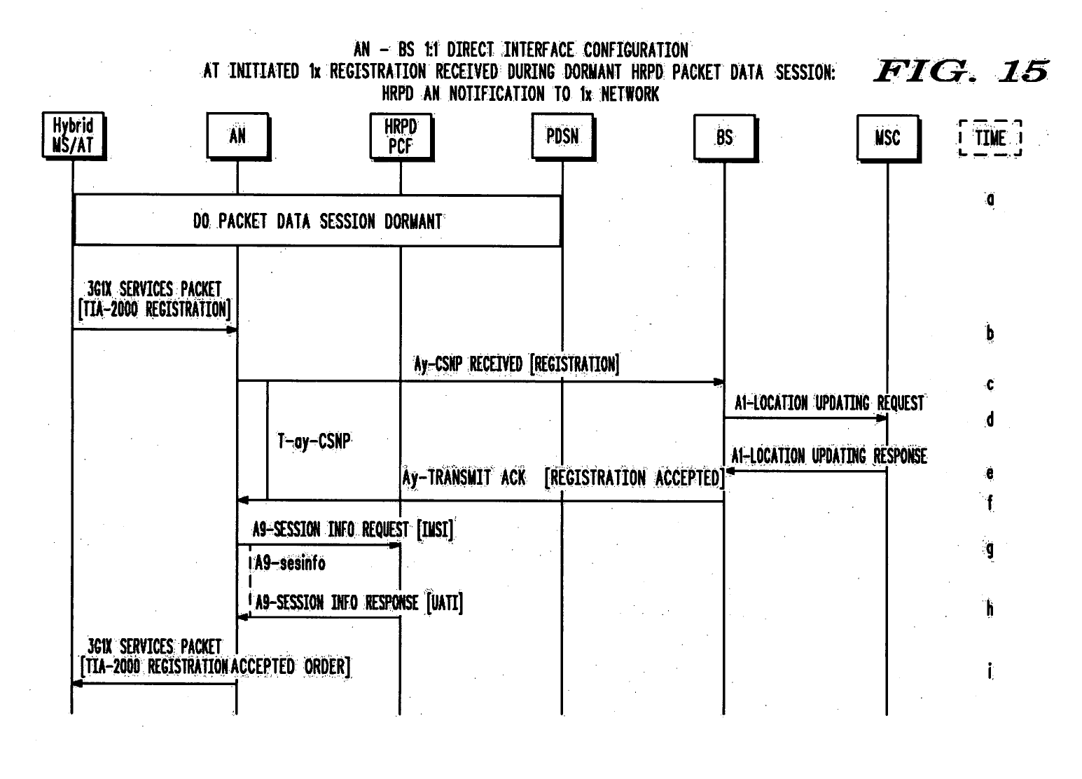

FIG. 15 is an exemplary call flow diagram depicting an AT initiated 3G1X registration during a dormant packet data session on an HRPD network for an AN-BS 1:1 direct interface configuration, in accordance with multiple embodiments of the present invention. The following is a detailed description of the call flow timeline as labeled on the rightmost column of FIG. 15:
a. The Hybrid AT is engaged in a dormant packet data session in an overlaid HRPD network.
b. The Hybrid AT sends a 3G1X Services Packet containing a TIA-2000 Registration message to the AN.
c. The AN forwards the mobile's Registration message in the Ay-Registration Update Request message to the HRPD anchored BS. The AN then starts timer T_{ay-csnp}.
d. Upon reception of the Ay-Registration Update Request message from the HRPD AN, the BS constructs a Location Updating Request message, places it in the Complete Layer 3 Information message, and sends it to the MSC. The BS then starts timer T₃₂₁₀.
e. The MSC sends the Location Updating Accept message to the BS to indicate that the Location Updating Request message has been processed. The AT is now registered at the MSC at the HRPD anchor BS. Upon receipt of the Location Updating Accept message, the BS stops timer T₃₂₁₀.
f. The BS sends an Ay-CSNP Ack (no message to send to MS) or Ay-CSNP Transmit Ack message containing a Registration Accepted Order to the HRPD AN. The mobile IMSI is included in the message. Upon receipt of either message, the AN stops timer T_{ay-csnp}.

The next steps only occur if the BS sent an Ay-CSNP Transmit Ack message to the AN
g. The AN sends an A9-Session Info request message with the received IMSI to the PCF and starts the T_{A9-sessinfo} timer.
h. The PCF uses the received IMSI to locate the UATI allocated to the AT and sends it back to the AN in the A9-Session Info Response message. The AN stops the T_{A9-sessinfo} timer.
i. The AN sends a 3G1x Services Packet Registration Accepted Order to the MS to indicate a successful ordered registration procedure.

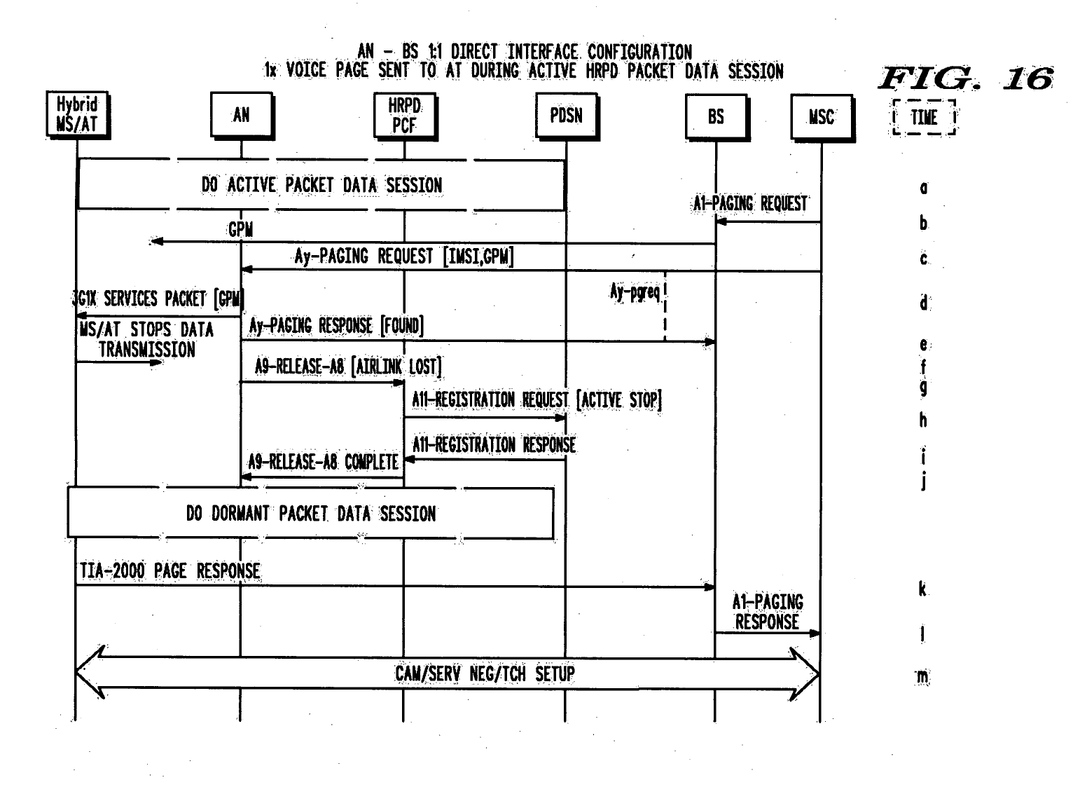

FIG. 16 is an exemplary call flow diagram depicting a 1X voice page for an AT during an active HRPD packet data session for an AN-BS 1:1 direct interface configuration, in accordance with multiple embodiments of the present invention. The following is a detailed description of the call flow timeline as labeled on the rightmost column of FIG. 16:
a. A hybrid AT is engaged in an active packet data session on an overlaid HRPD packet data network. The PCF sends the IMSI to the AT when the A8 bearer connection is established. The AN maintains the AT's IMSI/UATI mapping while it's packet data session is active.
b. The MSC determines that an incoming call terminates to an AT within its serving region and sends a A1-Paging Request message to the 1xBS BS to initiate a mobile terminated call setup procedure. The MSC is unaware that the AT is engaged in a packet data session at the HRPD network. The MSC starts timer T₃₁₁₃.
c. The BS sends a Page message in a GPM over the air, and Ay-Paging Request messages (containing 1x GPM message and IMSI) to the HRPD AN. The BS starts timer T_{Ay-pgreq}.
d. The AN uses the received IMSI to find the UATI assigned to the AT to be paged. The AN sends a 3G1X Services Packet containing a 1x GPM to the AT.
e. The AN responds with an Ay-Paging Response message to the BS indicating that the AT was found. The BS stops timer T_{Ay-pgreq} upon receipt of the Paging Response message from the BS.
f. The AT stops data transmission to the HRPD network.
g. The AN detects the loss of transmission after a timeout and sends an A9-Release A8 message to the PCF with cause value indicating ‘Air link lost’ to the PCF and starts timer Tᵣₑₗ₉.
h. The PCF sends an A11-Registration Request message containing an Active Stop accounting record to the PDSN and starts timer T_{regreq}. If the PDSN supports GRE packet flow control for the connection, the PCF may requess flow control be started if supported for the connection to prevent a network initiated reactivation of the packet data session.
i. The PDSN sends an A11-Registration Reply message to the PCF. The PCF stops timer T_{regreq} upon receipt of this message.
j. The PCF sends an A9-Release-A8 Complete message to the AN. The AN stops timer Tᵣₑₗ₉.
k. The AT sends a 1x Page Response message to the BS. This step may occur any time after step e.
l. The BS sends a Page Response message to the MSC.
m. Existing TIA-2000 and IOS procedures are used to complete the set up of the 1x voice call.

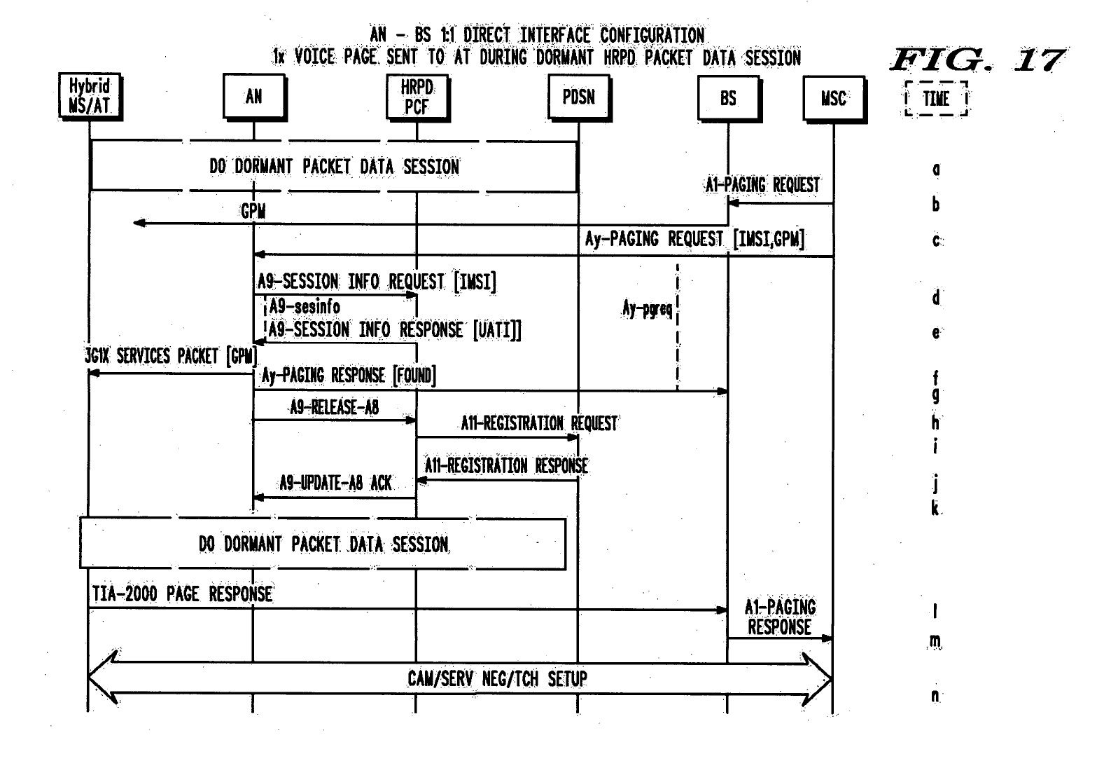

FIG. 17 is an exemplary call flow diagram depicting a 1X voice page for an AT during a dormant HRPD packet data session for an AN-BS 1:1 direct interface configuration, in accordance with multiple embodiments of the present invention. The following is a detailed description of the call flow timeline as labeled on the rightmost column of FIG. 17:
a. A hybrid AT is engaged in a dormant packet data session on an overlaid HRPD packet data network.
b. The MSC determines that an incoming call terminates to an AT within its serving region and sends a A1-Paging Request message to the 1x BS to initiate a mobile terminated call setup procedure. The MSC is unaware that the AT is engaged in a packet data session at the HRPD network. The MSC starts timer T₃₁₁₃.
c. The BS forwards the Page message in a GPM over the air and in an Ay-Paging Request message to ANs in the HRPD network. The HRPD Anchor BS starts timer T_{Ay-pgreq}.
d. The AN is unable to match the IMSI received in the Ay-Paging Request message to a UATI allocated for an active packet data call on the AN. The AN sends an A9-Session Info request message with the received IMSI to the PCF and starts the T_{A9-sessinfo} timer. The AN may request the PCF to initiate flow control with the PDSN for the dormant session so the mobile doesn't receive a network initiated packet data session.
e. The PCF uses the received IMSI to locate the UATI allocated to the AT and sends it back to the AN in the A9-Session Info Response message. The AN stops the T_{A9-sessinfo} timer.
f. The AN sends a 3G1X Services Packet containing a 1x GPM to the AT.
g. The AN responds with an Ay-Paging Response message to the HRPD Anchor BS indicating that the AT was found. The BS stops timer T_{Ay-pgreq} upon receipt of the Paging Response message from the BS.

Steps h-k only occur if the packet data session is to be released at the HRPD network. Alternatively the session is remains dormant and flow control is requested of the PDSN if supported by the PDSN for the packet data connection.
h. The AN sends and A9-Update-A8 message to the PCF. The AN may request the PCF to initiate flow control with the PDSN for the dormant session so the mobile doesn't receive a network initiated packet data session.
i. The PCF sends an A11-Registration Request message to the PDSN.
j. The PDSN responsds with an A11-Registration Reply message.
k. The PCF sends and A9-Update-A8-Ack message to the AN, The An stops the A9update timer.
l. The AT sends a Page Response message to the BS. This step can occur any time after step g.
m. The BS sends a Page Response message to the MSC.
n. Existing TIA-2000 and IOS procedures are used to complete the set up of the 1x voice call.

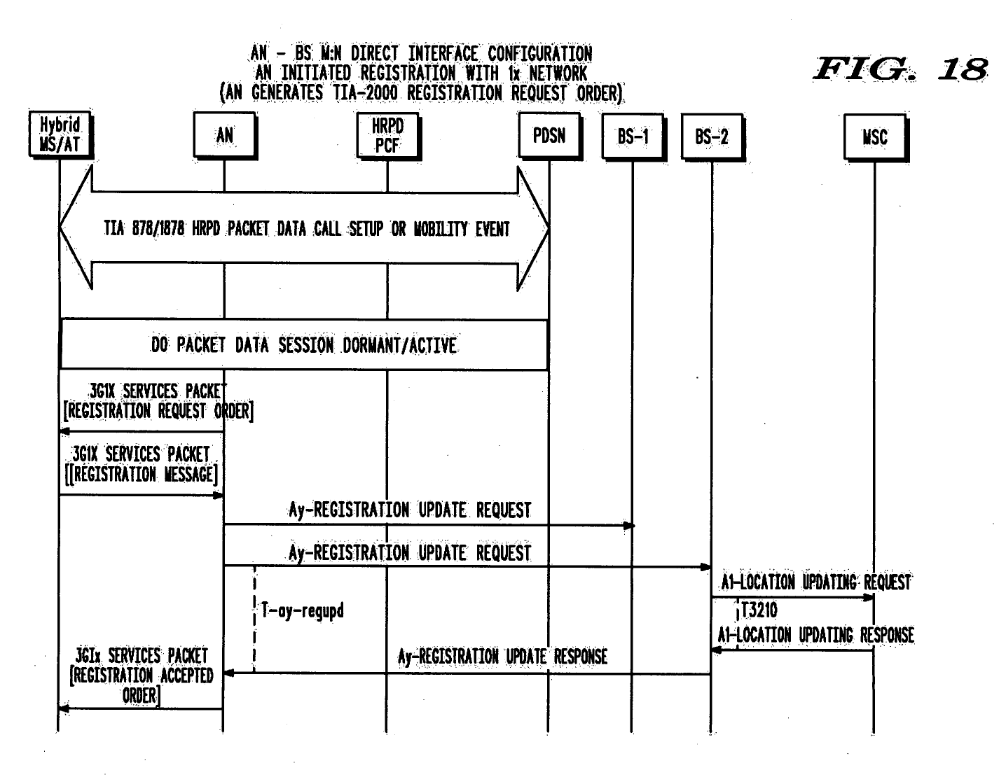

FIG. 18 is an exemplary call flow diagram depicting an AN initiated registration with 3G1X network for an AN-BS M:N direct interface configuration, in accordance with multiple embodiments of the present invention. Notes:
PCF shall send IMSI to ANC in A9-Connect-A8 (packet call setup) or A9-Release-A8 Complete (DMHO) to be used in Registration Request Order.
This registration procedure may be used when a new packet data call is established with the HRPD network, a mobility event occurs in the HRPD network (dormant/active handoff), or the MS/AT registers in the HRPD network.
ANC may have connections to multiple BSC. BSC that parents the 1x cell that is overlaid with the HRPD cell sends A1 messaging to MSC and responds to ANC over Ay.
PCF initiates 1x registration by including an indication in the A9-Connect-A8 (for initial hrpd call setup or after hrpd mobility event—hho/dmho).
The existing A1 Location Updating procedure for Registration is used. An ideal overlay should not encompass multiple paging zones under the same 1x BTS, however should this occur, the design is robust enough to support it. For the case that an HRPD cell overlays 1x-BTSs belonging to different registration zones, location updates from multiple BSCs may reach the MSC.

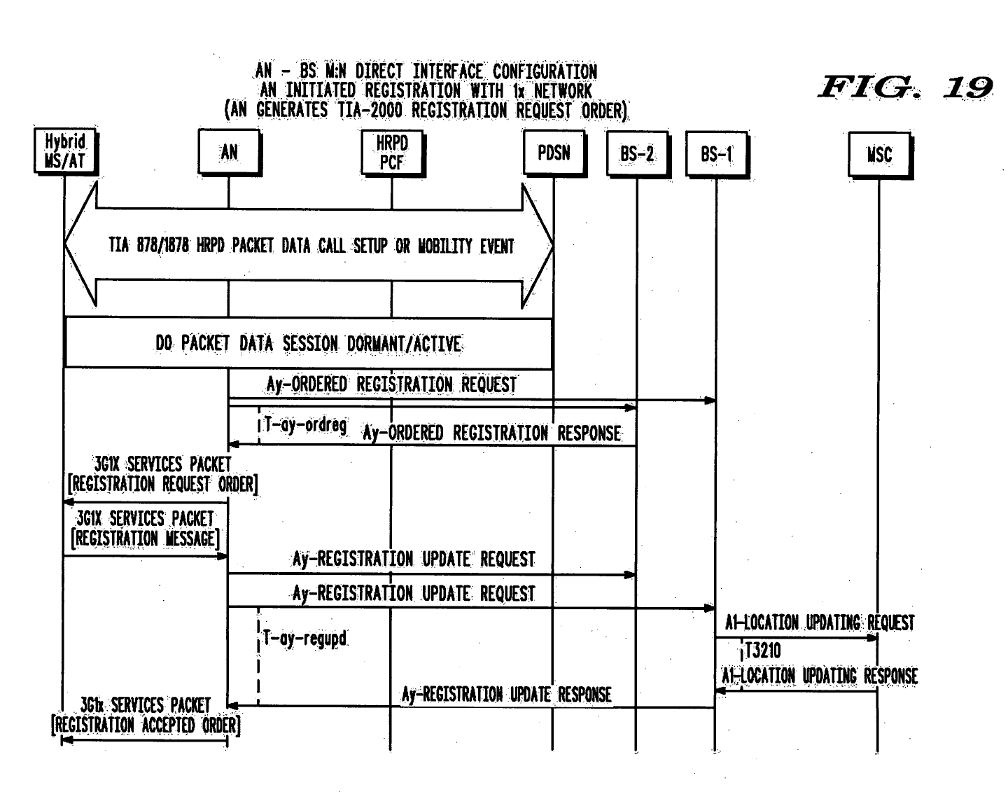

FIG. 19 is an exemplary call flow diagram depicting an AN initiated registration with 3G1X network for an AN-BS M:N direct interface configuration, in accordance with multiple embodiments of the present invention.

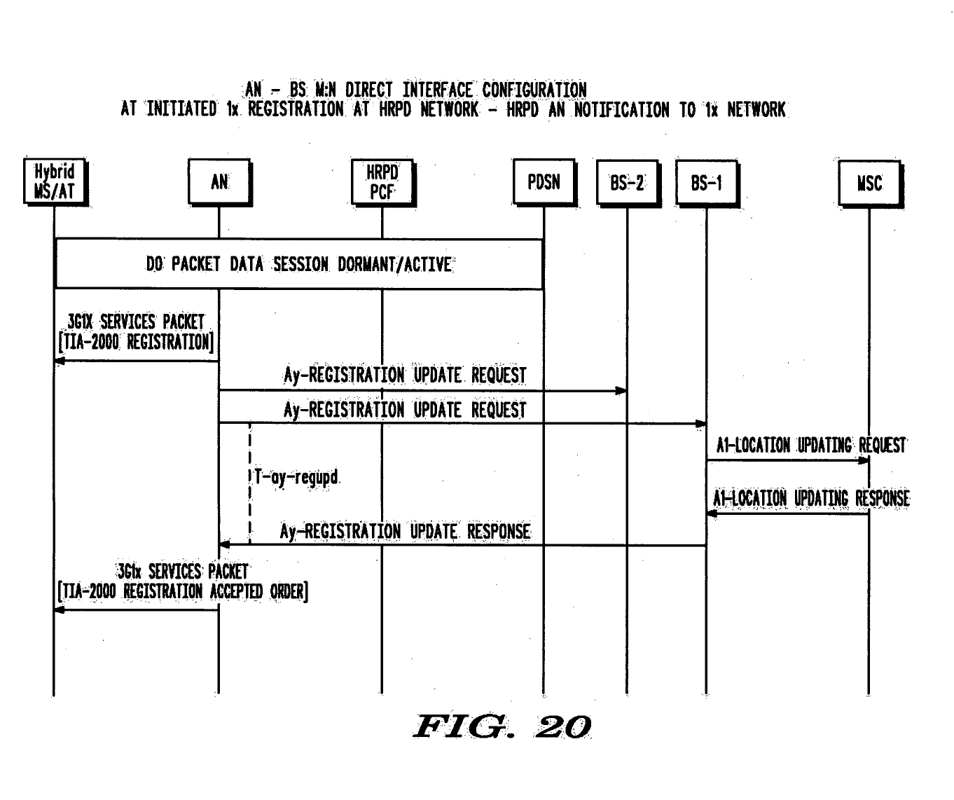

FIG. 20 is an exemplary call flow diagram depicting an AT initiated 3G1X registration on an HRPD network for an AN-BS M:N direct interface configuration, in accordance with multiple embodiments of the present invention. Notes:
AN may have connections to multiple BSs. BSC that parents the 1x cell that is overlaid with the HRPD cell sends A1 messaging to MSC and responds to AN over Ay.

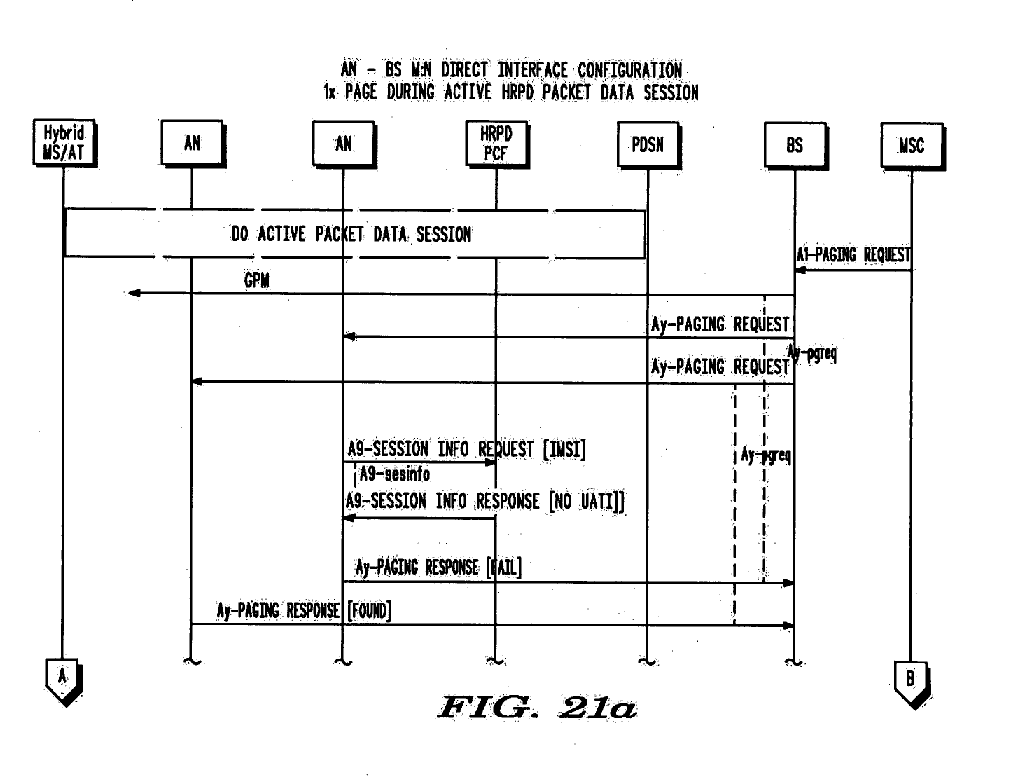

FIG. 21 is an exemplary call flow diagram depicting a 1X voice page for an AT during an active HRPD packet data session for an AN-BS M:N direct interface configuration, in accordance with multiple embodiments of the present invention. Notes:
Double paging can be reduced or avoided by staggered re-paging or maintaining HRPD registration status at the 1x-BSC.

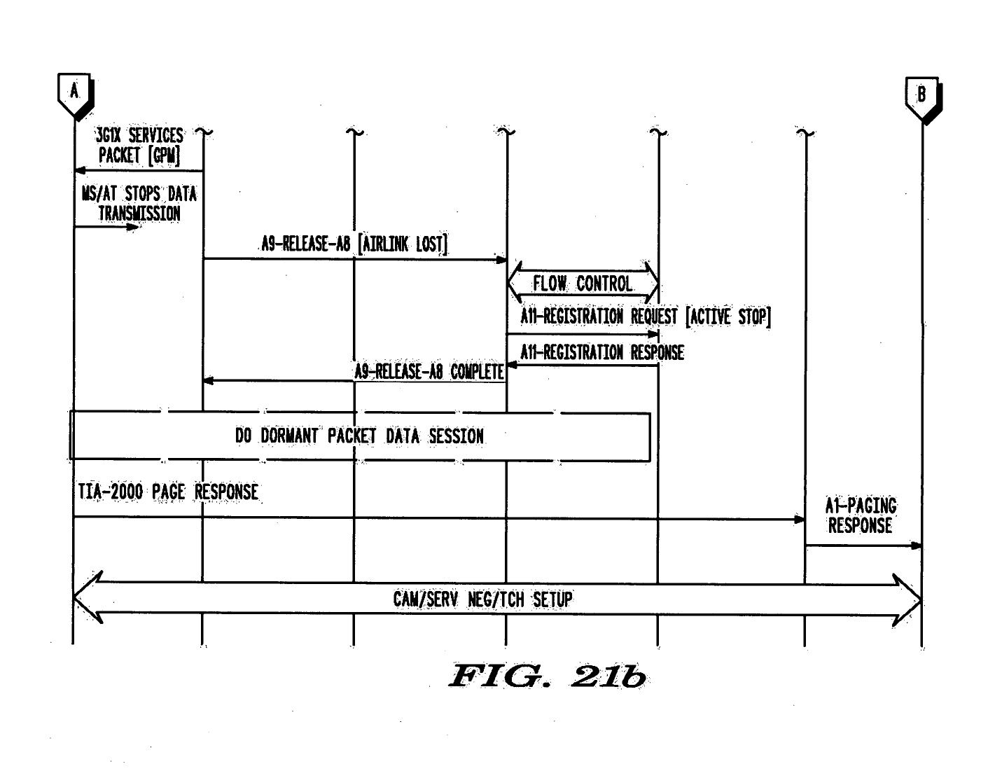

FIG. 22 is an exemplary call flow diagram depicting an HRPD PCF initiated registration with 3G1X network, in accordance with multiple embodiments of the present invention. Notes:
The bi-directional mapping between the IMSI and the UATI occurs at the HRPD PCF regardless if the HRPD session is active or dormant. HRPD PCF requests 1X BS to initiate Registration Request Order This registration procedure may be used when a new packet data call is established with the HRPD network, a mobility event occurs in the HRPD network (dormant/active handoff), or the MS/AT registers in the HRPD network.
PCF initiates 1x registration by including an indication in the A9-Connect-A8 (for initial hrpd call setup or after hrpd mobility event—hho/dmho).
The existing A1 Location Updating procedure for Registration is used.

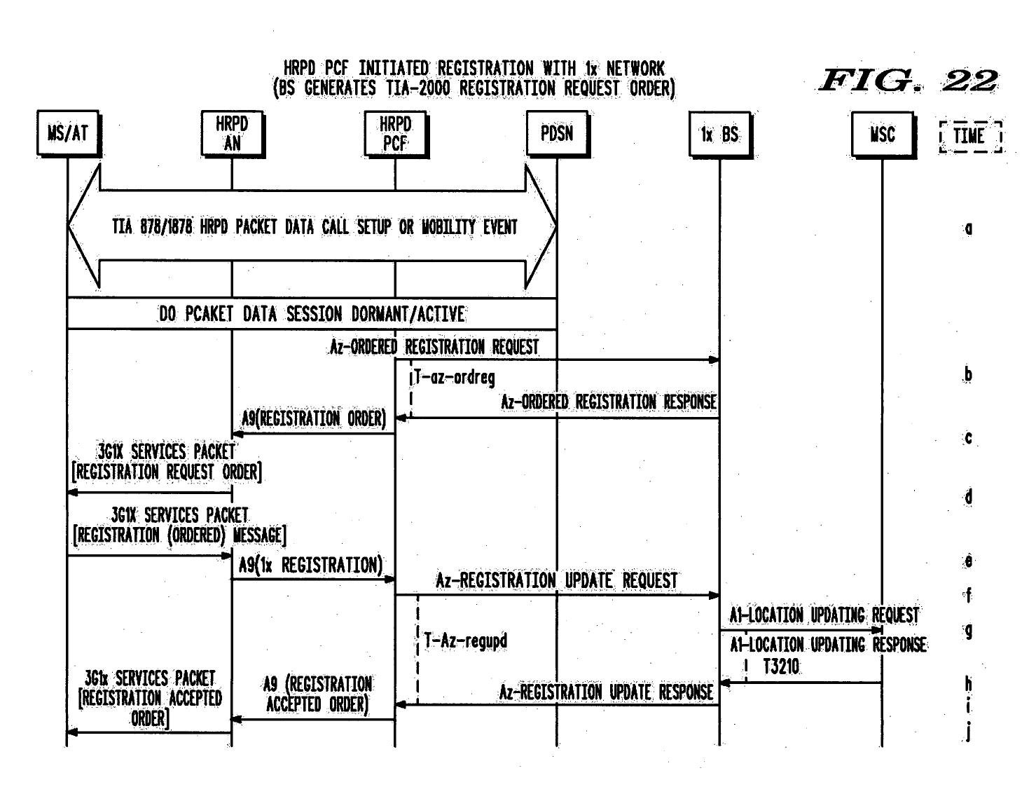

FIG. 23 is an exemplary call flow diagram depicting an AT initiated 3G1X registration on an HRPD network, in accordance with multiple embodiments of the present invention. The following is a detailed description of the call flow timeline as labeled on the rightmost column of FIG. 23:
a. The Hybrid AT is engaged in packet data call with an overlaid HRPD network. The packet data session may be in a dormant or active.
b. The Hybrid AT sends a 3G1X Services Packet containing a TIA-2000 Registration message to the AN.
c. The AN forwards the mobile's Registration message in the tunneled A9 message and Az-Registration Update Request message to the HRPD PCF which sends it to the 1X BS.
d. Upon reception of the Az-Registration Update Request message, the BS constructs a Location Updating Request message, places it in the Complete Layer 3 Information message, and sends it to the MSC. The BS then starts timer T₃₂₁₀.
e. The MSC sends the Location Updating Accept message to the BS to indicate that the Location Updating Request message has been processed. The AT is now registered at the MSC at the HRPD anchor BS. Upon receipt of the Location Updating Accept message, the BS stops timer T₃₂₁₀. Optionally, the anchor BS maps the AT's IMSI to the AN.
f. The HRPD anchor BS sends an Az-Registration Update Response message to the HRPD PCF which sends it to AN as a A9 message.
g. The AN may transmit a 3G1X Services Packet containing a TIA-2000 Registration Accepted Order to the MS to indicate a successful location registration operation.

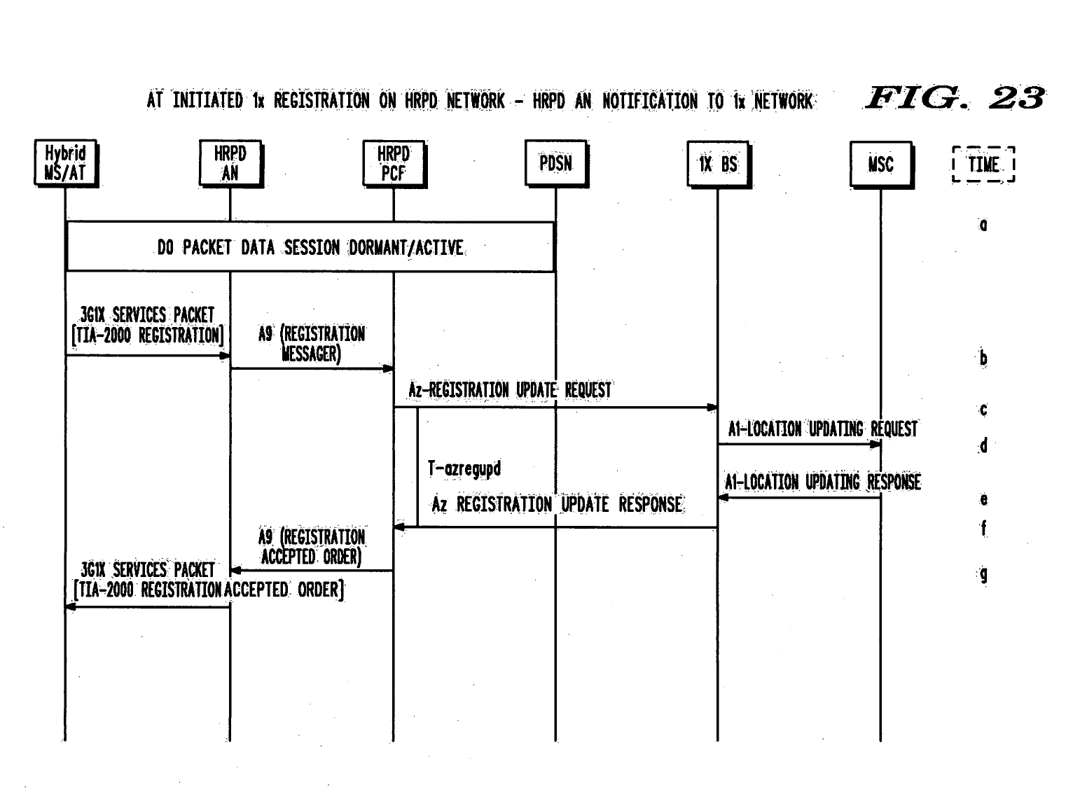

FIG. 24 is an exemplary call flow diagram depicting a 1X voice page for an AT during an active/dormant HRPD packet data session, in accordance with multiple embodiments of the present invention. The following is a detailed description of the call flow timeline as labeled on the rightmost column of FIG. 24:
a. A hybrid AT is engaged in an active packet data session on an overlaid HRPD packet data network. The PCF sends the IMSI when the A8 bearer connection is established. If included in the A9-Connect-A8 message, it avoids additional procedure to retrieve IMSI when a page is sent from the 1x network. If not included, then BS must retrieve IMSI from PCF as is done for cross paging a dormant AT
b. The MSC determines that an incoming call terminates to an AT within its serving region and sends a A1-Paging Request message to the 1X BS to initiate a mobile terminated call setup procedure. The MSC is unaware that the AT is engaged in a packet data session at the HRPD network. The MSC starts timer T₃₁₁₃.
c. The 1X BS sends a Page message in a GPM over the air, and Az-Paging Request messages (containing the A1-Paging Request message) to HRPD PCF which forwards it to the AN on A9.
d. The AN responds to the PCF via A9 and PCF forwards the response via an Az-Paging Response message to the 1X BS.
e. The AN sends a 3G1X Services Packet containing a 1x GPM to the AT.
f. The AT stops data transmission to the HRPD network.
g. The AN detects the loss of transmission after a timeout and sends an A9-Release A8 message to the PCF with cause value indicating ‘Air link lost’ to the PCF and starts timer Tᵣₑₗ₉.
h. The PCF sends an A11-Registration Request message containing an Active Stop accounting record to the PDSN and starts timer T_{regreq}. If the PDSN supports GRE packet flow control for the connection, the PCF requests flow control be started. (The PCF may optionally release the packet data session).
i. The PDSN sends an A11-Registration Reply message to the PCF. The PCF stops timer T_{regreq} upon receipt of this message.
j. The PCF sends an A9-Release-A8 Complete message to the AN. The AN stops timer Tᵣₑₗ₉.
k. The AT sends a 1x Page Response message to the BS. This step may occur any time after step e.
l. The BS sends a Page Response message to the MSC.
m. Existing TIA-2000 and IOS procedures are used to complete the set up of the 1x voice call.

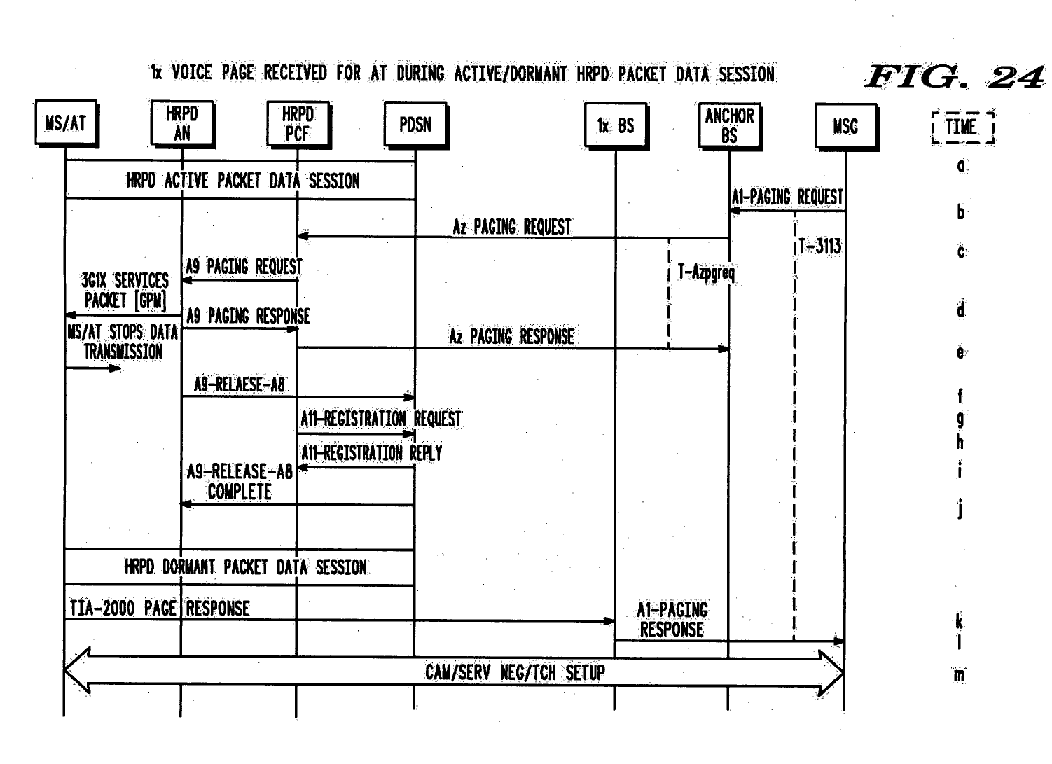

FIG. 25 is an exemplary call flow diagram depicting a RL message supported by the CSNP protocol received an active/dormant HRPD packet data session, in accordance with multiple embodiments of the present invention. The following is a detailed description of the call flow timeline as labeled on the rightmost column of FIG. 25:
a. A hybrid AT is engaged in a packet data session on an overlaid HRPD packet data network.
b. A hybrid AT engaged in a packet data session on an HRPD network sends TIA-2000 Data Burst or Order message to the AN.
c. The AN forwards the received message in an Ay-CSNP Received message to the 1x BS and starts timer T_{ay-csnp}.
d. The 1x BS extracts the air interface message from the Ay-CSNP Received message and performs existing A1 procedure associated with the received message with the MSC.
e. The 1x BS sends back an Ay-CSNP Ack message to the HRPD AN. The HRPD AN stops timer T_{ay-csnp}. Either an acknowledgement or response may be sent back to the AT if required.

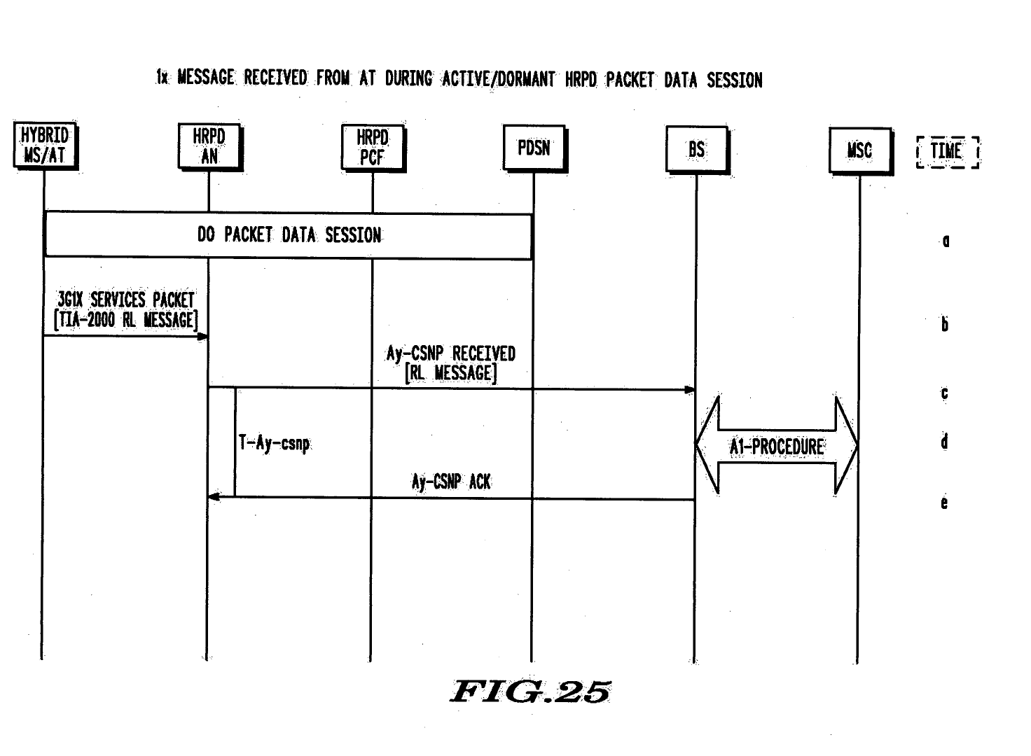

Appendix material with reference to FIGS. 26-29 follows.

IOS interfaces:
A1 The A1 interface carries signaling information between the call control and mobility management functions of the MSC and the call control component of the BS (BSC).
A2 The A2 interface is used to provide a path for user traffic. The A2 interface carries 64/56 kbps PCM information (for circuit-oriented voice) or 64 kbps Unrestricted Digital Information (UDI, for ISDN) between the Switch component of the MSC and the Selection/Distribution Unit (SDU) function of the BS.
A3 The A3 interface is used to transport user traffic and signaling for inter-BS soft/softer handoff when a target BS is attached to the frame selection function within the source BS. The A3 interface carries coded user information (voice/data) and signaling information between the source BS SDU function and the channel element component (BTS) of the target BS. This is a logical description of the endpoints of the A3 interface. The physical endpoints are beyond the scope of this specification. The A3 interface is composed of two parts: signaling and user traffic. The signaling information is carried across a separate logical channel from the user traffic channel, and controls the allocation and use of channels for transporting user traffic.
A5 The A5 interface is used to provide a path for user traffic for circuit-oriented data calls between the source BS and the MSC. The A5 interface carries a full duplex stream of bytes between the switch component of the MSC and the SDU function of the BS.
A7 The A7 interface carries signaling information between a source BS and a target BS for inter-BS soft/softer handoff.
A8 The A8 interface carries user traffic between the BS and the PCF.
A9 The A9 interface carries signaling information between the BS and the PCF.
A10 The A10 interface carries user traffic between the PCF and the PDSN.
A11 The A11 interface carries signaling information between the PCF and the PDSN.

This is a logical architecture that does not imply any particular physical implementation. For this standard the IWF for circuit-oriented data calls is assumed to be located at the MSC, and the SDU function is considered to be co-located with the source BSC. FIG. 26 shows the relationship among network components in support of mobile originations, mobile terminations, and direct BS-to-BS soft/softer handoff operations. The IOS interfaces provide:
bearer (user traffic) connections (A2, A3 (traffic), A5, A8, and A10);
a signaling connection between the channel element component of the BS and the SDU function (A3 signaling);
a direct BS to BS signaling connection (A7);
a signaling connection between the BS and the MSC (A1);
a signaling connection between the BS and PCF (A9); and
a signaling connection between a PCF and PDSN pair (A11). A11 signaling messages are also used for passing accounting related and other information from the PCF to the PDSN.

In general, the functions specified on the interfaces are based on the premise that the interfaces carry signaling information that traverses the following logical paths:
between the BS and MSC only (e.g., BS management information);
between the MS and the MSC via the BS (e.g., the BS maps air interface messages to the A1 interface);
between the BS and other network elements via the MSC;
between the source BS and the target BS;
between the BS and the PCF;
between the PCF and the PDSN; and
between the MS and the PDSN (e.g., authorization information and Mobile Internet Protocol (MIP) signaling).

These logical paths define all of the traffic that can exist on the defined interfaces.

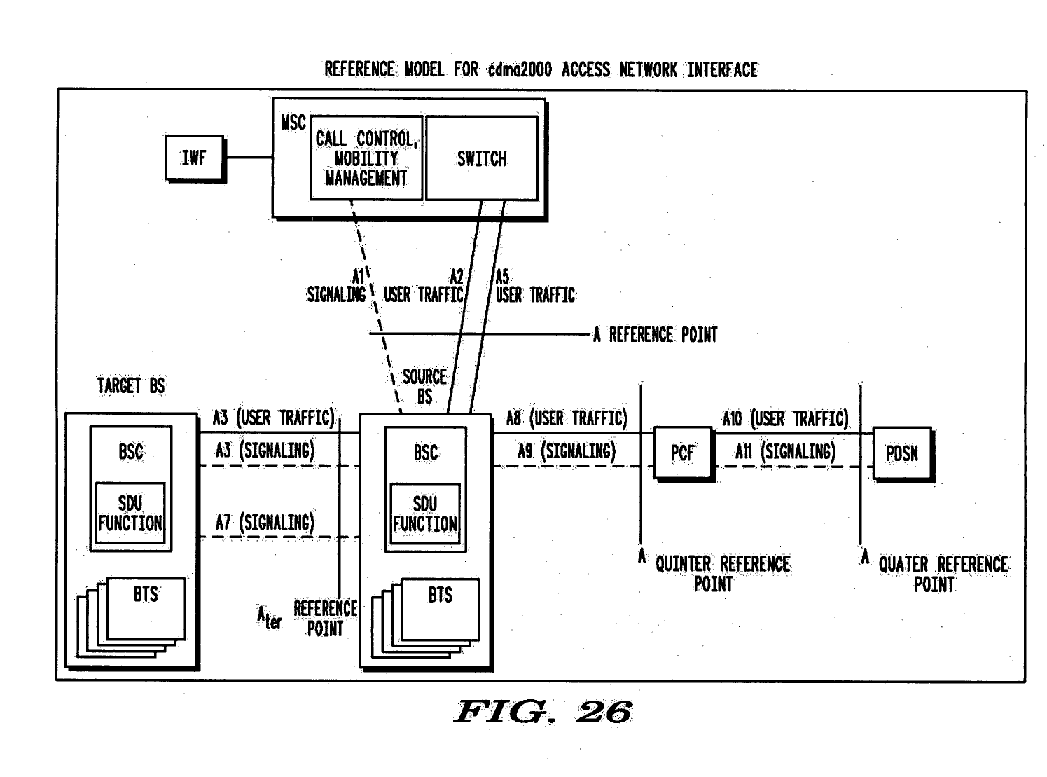

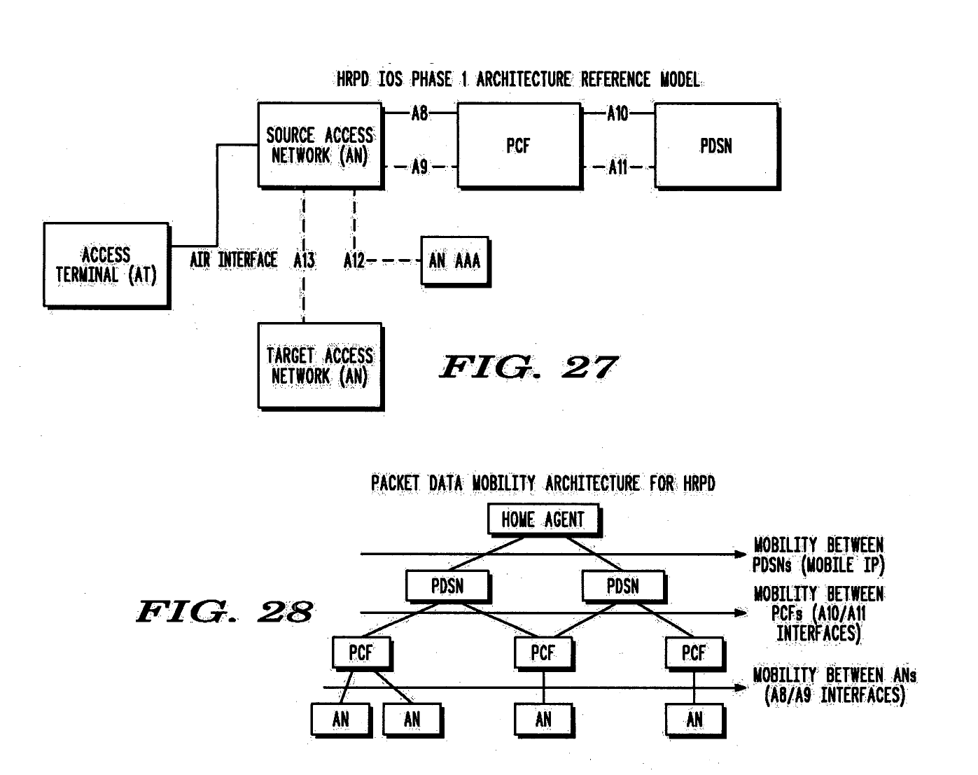

HRPD IOS Architecture Reference Model (TIA-878) (SC/MM in AN):
The HRPD IOS messaging and call flows are based on the Architecture Reference Model shown in FIG. 27, HRPD IOS Phase 1. FIG. 28 provides a conceptual view of levels of HRPD packet data mobility. The A8/A9 interfaces support mobility between ANs under the same PCF. The A10/A11 interfaces support mobility between PCFs under the same PDSN. Mobile IP supports mobility between PDSNs under the same Home Agent. Definitions:
Access Authentication A procedure in which the Access Terminal (AT) is authenticated by the AN-MA (Access Network Authentication, Authorization and Accounting entity).
Access Stream The HRPD stream whose end-points are the access terminal and the access network (radio network). This stream is used for access authentication.
Access Network The network equipment providing data connectivity between a packet switched data net-work (typically the Internet) and the access terminals. An access network is equivalent to a base station in cdma2000 systems.
Access Terminal A device providing data connectivity to a user. An access terminal may be connected to a computing device such as a laptop personal computer or it may be a self-contained data device such as a personal digital assistant. An access terminal is equivalent to a mobile station in cdma2000 systems.
AN-AAA An entity that performs access authentication and authorization functions for the Access Network.
Connection A connection is a particular state of the air-link in which the access terminal is assigned a Forward Traffic Channel, a Reverse Traffic Channel and associated Medium Access Control (MAC) Channels. During a single HRPD session the access terminal and the access network can open and can close a connection multiple times.
Hybrid MS/AT A device capable of operating on both cdma2000 and HRPD access networks.
Service Stream The HRPD stream used when exchanging data between the access terminal and the PDSN.
HRPD session An HRPD session refers to a shared state between the access terminal and the access network. This shared state stores the protocols and protocol configurations that were negotiated and are used for communications between the access terminal and the access network. Other than to open a session, an access terminal cannot communicate with an access network without having an open session. Note that it is possible that the A10/A11 connection is not established even though the HRPD session is established.
Packet Data Session An instance of use of packet data service by a mobile user. A packet data session begins when the user invokes packet data service. A packet data session ends when the user or the network terminates packet data service. During a particular packet data session, the user may change locations but the same IP address is maintained.

IOS interfaces:
A12 The A12 interface carries signaling information related to terminal authentication between the SC/MM function in the PCF and the AN-AAA (Authentication, Authorization and Accounting entity).
A13 The A13 interface carries signaling information between the SC/MM function in the source PCF and the SC/MM function in the target PCF.
A14 The A14 interface carries signaling information between the SC/MM function in the PCF and the AN.
A15 The A15 interface carries signaling information between ANs when inter-AN paging is used.
Ax The Ax interface carries user traffic between the SC/MM function in the PCF and the AN.

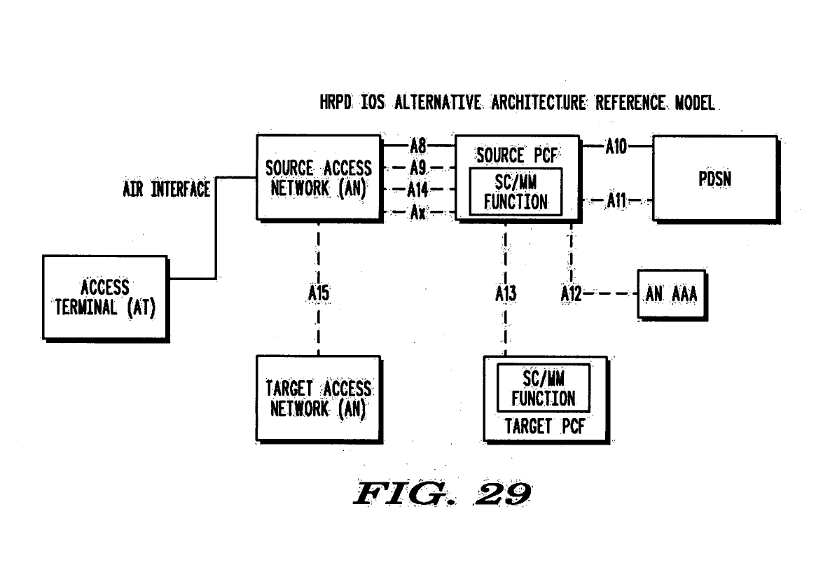

HRPD IOS Alternative Architecture Reference Model (SC/MM in PCF):
The HRPD IOS messaging and call flows are based on the Alternative Architecture Reference Model shown in FIG. 29. The A8/A9/A14 interfaces support mobility between ANs under the same PCF. The A10/A11/A13 interfaces support mobility between PCFs under the same PDSN. Mobile IP supports mobility between PDSNs under the same Home Agent.

In the foregoing specification, the present invention has been described with reference to specific embodiments. However, one of ordinary skill in the art will appreciate that various modifications and changes may be made without departing from the spirit and scope of the present invention as set forth in the appended claims. Accordingly, the specification and drawings are to be regarded in an illustrative rather than a restrictive sense, and all such modifications are intended to be included within the scope of the present invention. In addition, those of ordinary skill in the art will appreciate that the elements in the drawings are illustrated for simplicity and clarity, and have not necessarily been drawn to scale. For example, the dimensions of some of the elements in the drawings may be exaggerated relative to other elements to help improve an understanding of the various embodiments of the present invention.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims. As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

1. A method to facilitate inter-operability between a 3G1x network and a wireless packet data network comprising:
receiving, by a 3G1x radio access network (RAN), registration update messaging for a remote unit from a packet data network RAN;
in response to receiving the registration update messaging:
sending, by the 3G1x RAN, 3G1x registration update messaging for the remote unit to a mobile switching center (MSC);
sending, by the 3G1x RAN, registration response messaging for the remote unit to the packet data network RAN.

2. The method of claim 1 further comprising receiving, by the 3G1x RAN, registration response messaging for the remote unit from the MSC prior to sending the registration response messaging.

3. The method of claim 1, wherein the 3G1x RAN comprises a base station and a PCF.

4. The method of claim 3, wherein receiving, by the 3G1x RAN, the registration update messaging for the remote unit from the packet data network RAN comprises receiving the registration update messaging by the base station.

5. The method of claim 4, wherein receiving the registration update messaging by the base station comprises receiving the registration messaging via the packet control function (PCF).

6. A method to facilitate inter-operability between a 3G1x network and a wireless packet data network comprising:
receiving, by a packet data network radio access network (RAN), registration signaling from a remote unit;
in response to receiving the registration signaling:
sending, by the packet data network RAN, registration messaging for the remote unit to a 3G1x RAN;
sending, by the packet data network RAN, registration response signaling to the remote unit.

7. The method of claim 6 further comprising receiving, by the packet data network RAN, registration response messaging for the remote unit from the 3G1x RAN prior to sending the registration response signaling.

8. The method of claim 6, wherein the packet data network RAN comprises a packet data network access network (AN) and a packet data network packet control function (PCF).

9. The method of claim 8, wherein sending, by the packet data network RAN, the registration messaging for the remote unit to the 3G1x RAN comprises sending the registration messaging by the packet data network AN.

10. The method of claim 8, wherein sending, by the packet data network RAN, the registration messaging for the remote unit to the 3G1x RAN comprises sending the registration messaging by the packet data network PCF.

11. The method of claim 6 wherein sending, by the packet data network RAN, registration messaging for the remote unit to the 3G1x RAN comprises sending registration messaging for the remote unit to multiple 3G1x base stations.

12. A method to facilitate inter-operability between a 3G1x network and a wireless packet data network comprising:
receiving, by a 3G1x radio access network (RAN), circuit network-originated paging request messaging for a remote unit from a mobile switching center (MSC);
sending, by the 3G1x RAN in response to receiving the circuit network-originated paging request messaging, RAN-originated paging request messaging for the remote unit to a packet data network RAN;
receiving, by the 3G1x RAN in response to sending the RAN-originated paging request messaging, page response messaging for the remote unit.

13. The method of claim 12, wherein receiving page response messaging by the 3G1x RAN comprises receiving page response messaging from the packet data network RAN.

14. The method of claim 12, wherein receiving page response messaging by the 3G1x RAN comprises receiving page response messaging from the remote unit.

15. The method of claim 14, further comprising sending, by the 3G1x RAN in response to receiving page response messaging from the remote unit, RAN-originated page response messaging to the MSC for the remote unit.

16. The method of claim 12 wherein sending, by the 3G1x RAN, RAN-originated paging request messaging for the remote unit to the packet data network RAN comprises sending RAN-originated paging request messaging for the remote unit to multiple packet data network RANs.

17. The method of claim 12 further comprising paging the remote unit by the 3G1x RAN in response to receiving the circuit network-originated paging request messaging.

18. A method to facilitate inter-operability between a 3G1x network and a wireless packet data network comprising:
receiving, by a packet data network radio access network (RAN), RAN-originated paging request messaging for a remote unit from a 3G1x RAN;
paging the remote unit by the packet data network RAN in response to receiving the RAN-originated paging request messaging;
sending, by the packet data network RAN in response to receiving the RAN-originated paging request messaging, RAN-originated page response messaging to the 3G1x RAN.

19. The method of claim 18, further comprising:
detecting, by the packet data network RAN, that data transmission from the remote unit has stopped subsequent to paging the remote unit;
triggering, by the packet data network RAN in response to detecting, a transition of the remote unit to a packet data network dormant packet data session.

20. The method of claim 18, further comprising sending by the packet data network RAN a request to a PDSN to stop sending packet data for the remote unit.
